(19) United States
(12) Patent Application Publication
(10) Pub. No.: US 2021/0012114 A1
(43) Pub. Date: Jan. 14, 2021

(54) SEGMENTING VIDEO STREAM FRAMES

(71) Applicant: Banjo, Inc., South Jordan, UT (US)

(72) Inventors: Joshua J. Newman, Park City, UT (US); Krishnamohan Pathicherikollamparambil, Salt Lake City, UT (US); Brian Rodriguez, Salt Lake City, UT (US)

(21) Appl. No.: 16/922,235

(22) Filed: Jul. 7, 2020

Related U.S. Application Data
(60) Provisional application No. 62/872,011, filed on Jul. 9, 2019.
(60) Provisional application No. 62/875,878, filed on Jul. 18, 2019.

(51) Int. Cl. G06K 9/00; G06T 7/70

(52) U.S. Cl. CPC G06K 9/00765; G06T 7/70; G06T 2207/30236; G06K 9/00718; G06T 2207/10016; G06K 9/00651

(57) ABSTRACT

The present invention extends to methods, systems, and computer program products for segmenting video stream frames. In one aspect, video stream frames are segmented into more relevant segments (e.g., including roadway) and less relevant segments (e.g., not including roadway). Different segments can be handled differently. For example, more relevant segments can be processed to identify vehicles, identify events, etc. and less relevant segments may be ignored. Accordingly, resources can be utilized more efficiently. In one aspect, a binary mask is generated from object data in one or more frames. The binary mask is applied to further frames blocking out less relevant frame segments in the further frames.

### CROSS-REFERENCE TO RELATED APPLICATIONS

This application claims the benefit of U.S. Provisional Patent Application Ser. No. 62/872,011, entitled “Segmenting Video Stream Frames”, filed Jul. 9, 2019, which is incorporated herein in its entirety. This application claims the benefit of U.S. Provisional Patent Application Ser. No. 62/875,878, entitled “Segmenting Video Stream Frames”, filed Jul. 18, 2019, which is incorporated herein in its entirety.

### BACKGROUND

### 1. Background and Relevant Art

Entities (e.g., parents, guardians, friends, relatives, teachers, social workers, first responders, hospitals, delivery services, media outlets, government entities, etc.) may desire to be made aware of relevant events (e.g., fires, accidents, police presence, shootings, etc.) as close as possible to the events' occurrence. However, entities typically are not made aware of an event until after a person observes the event (or the event aftermath) and calls authorities.

In general, techniques that attempt to automate event detection are unreliable. Some techniques have attempted to mine social media data to detect the planning of events and forecast when events might occur. However, events can occur without prior planning and/or may not be detectable using social media data. Further, these techniques are not capable of meaningfully processing available data nor are these techniques capable of differentiating false data (e.g., hoax social media posts)

Other techniques use textual comparisons to compare textual content (e.g., keywords) in a data stream to event templates in a database. If text in a data stream matches keywords in an event template, the data stream is labeled as indicating an event.

Additional techniques use event specific sensors to detect specified types of event. For example, earthquake detectors can be used to detect earthquakes.

It may be that evidence of an event is contained in video. Video may be recorded video, for example, captured at a smart phone camera, that is uploaded in some way for viewing by others. Alternately, video can be live streaming video, for example, streaming from a smart phone camera, a traffic camera, another other public camera, or a private camera.

### BRIEF SUMMARY

Examples extend to methods, systems, and computer program products for segmenting video stream frames.

A frame is accessed from a camera video stream. A first object color mask is generated from the contents of the frame. Generating a first object color mask includes detecting objects of a plurality of different object types in the frame. The detected objects include a first instance of an object type and a first instance of another object type. Generating a first object color mask includes assigning a different color to different objects in the frame based on object type. Assigning different colors includes assigning a first color to the first instance of the object type and assigning a second color to the first instance of the other object type.

Generating a first object color mask includes determining the first instance of the object type is within the first instance of the other object type. Generating a first object color mask includes re-assigning the second color to the first instance of the object type.

Another frame is accessed from the camera video stream. A second object color mask is generated from contents of the other frame. Generating a second object color mask includes detecting other objects of the plurality of the different object types in the other frame. The detected objects include a second instance of the object type and a second instance of the other object type. Generating a second object color mask includes assigning a different color to different objects in the other frame based on the object type. Assigning different colors includes assigning the first color to the second instance of the object type and assigning a second color to the second instance of the other object type.

Generating a second object color mask includes determining the second instance of the object type is within the second instance of the other object type. Generating a second object color mask includes re-assigning the second color to the second instance of the object type.

The first object color mask and the second object color mask are combined into an aggregate color mask. A binary mask is computed from the aggregate color mask. Computing the binary mask includes assigning a binary value of one to portions of the aggregate color mask having the second color value and assigning a binary value of zero to portions of the aggregate color mask having other color values. The binary mask is applied to a further frame from the camera video stream highlighting instances of the other object type in the further frame.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1A illustrates an example computer architecture that facilitates ingesting signals.

FIG. 1B illustrates an example computer architecture that facilitates detecting events.

FIG. 2 illustrates a flow chart of an example method for normalizing ingested signals.

FIGS. 3A, 3B, and 3C illustrate other example components that can be included in signal ingestion modules.

FIG. 4 illustrates a flow chart of an example method for normalizing an ingested signal including time information, location information, and context information.

FIG. 5 illustrates a flow chart of an example method for normalizing an ingested signal including time information and location information.

FIG. 6 illustrates a flow chart of an example method for normalizing an ingested signal including time information.

FIGS. 7A-7E illustrate a computer architecture that facilitates segmenting video stream frames.

FIG. 8 illustrates a flow chart of an example method for segmenting video stream frames.

FIG. 9A depicts an example frame from a traffic camera.

FIG. 9B depicts an example color mask associated with the example frame of FIG. 9A.

FIG. 9C depicts an example binary mask for the example frame of FIG. 9A.

FIG. 9D depicts an example of the binary mask of FIG. 9C applied to a frame similar to the frame in FIG. 9A.

FIG. 9E depicts an example inverse binary mask for the example frame of FIG. 9A.

FIG. 9F depicts an example of the inverse binary mask of FIG. 9E applied to a frame similar to the frame in FIG. 9A.

### DETAILED DESCRIPTION

Examples extend to methods, systems, and computer program products for segmenting video stream frames.

When considering a video stream, it may be that some portions of the video stream are less relevant (and possibly irrelevant). For example, in a traffic camera video stream, portions including roadway may be more relevant and portions not including roadway may be less relevant. However, full frames of the video stream may none the less be processed even through portions of the frames are of limited (if any) relevance. Processing portions of a video stream having limited relevance is an inefficient use of resources. Processing portions of a video stream having limited relevance also makes tasks (e.g., event detection) more complex/difficult as there is more information to process and understand.

As such, aspects of the invention segment video stream frames. In one aspect, video stream frames are segmented into more relevant segments (e.g., including roadway) and less relevant segments (e.g., not including roadway). Different segments can be handled differently. For example, more relevant segments can be processed to identify vehicles, identify events, etc. and less relevant segments may be ignored. Accordingly, resources can be utilized more efficiently.

Implementations can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: raw signals, social signals, Web signals, streaming signals, normalized signals, events, search terms, geo cell data, geo cell subsets, event notifications, video streams, frames, objects, objects types, assigned colors, color mappings, color masks, defined object relationships, object subsets, reassigned colors, aggregate color masks, binary masks, masked frames, etc.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, raw signals, social signals, Web signals, streaming signals, normalized signals, events, search terms, geo cell data, geo cell subsets, event notifications, video streams, frames, objects, objects types, assigned colors, color mappings, color masks, defined object relationships, object subsets, reassigned colors, aggregate color masks, binary masks, masked frames, etc.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more Field Programmable Gate Arrays (FPGAs) and/or one or more application specific integrated circuits (ASICs) and/or one or more Tensor Processing Units (TPUs) can be programmed to carry out one or more of the systems and procedures described herein. Hardware, software, firmware, digital components, or analog components can be specifically tailor-designed for a higher speed detection or artificial intelligence that can enable signal processing. In another example, computer code is configured for execution in one or more processors, and may include hardware logic/electrical circuitry controlled by the computer code. These example devices are provided herein purposes of illustration, and are not intended to be limiting. Embodiments of the present disclosure may be implemented in further types of devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

In this description and the following claims, a “geo cell” is defined as a piece of “cell” in a grid in any form. In one aspect, geo cells are arranged in a hierarchical structure. Cells of different geometries can be used.

A “geohash” is an example of a “geo cell”.

In this description and the following claims, “geohash” is defined as a geocoding system which encodes a geographic location into a short string of letters and digits. Geohash is a hierarchical spatial data structure which subdivides space into buckets of grid shape (e.g., a square). Geohashes offer properties like arbitrary precision and the possibility of gradually removing characters from the end of the code to reduce its size (and gradually lose precision). As a consequence of the gradual precision degradation, nearby places will often (but not always) present similar prefixes. The longer a shared prefix is, the closer the two places are. geo cells can be used as a unique identifier and to represent point data (e.g., in databases).

In one aspect, a “geohash” is used to refer to a string encoding of an area or point on the Earth. The area or point on the Earth may be represented (among other possible coordinate systems) as a latitude/longitude or Easting/Northing—the choice of which is dependent on the coordinate system chosen to represent an area or point on the Earth. geo cell can refer to an encoding of this area or point, where the geo cell may be a binary string comprised of 0s and 1s corresponding to the area or point, or a string comprised of 0s, 1s, and a ternary character (such as X)—which is used to refer to a don't care character (0 or 1). A geo cell can also be represented as a string encoding of the area or point, for example, one possible encoding is base-32, where every 5 binary characters are encoded as an ASCII character.

Depending on latitude, the size of an area defined at a specified geo cell precision can vary. In one example, as shown in Table 1. the areas defined at various geo cell precisions are approximately:

TABLE 1
Example Areas at Various Geo Cell Precisions

| geo cell Length/Precision | width × height |
|---|---|
| 1 | 5,009.4 km × 4,992.6 km |
| 2 | 1,252.3 km × 624.1 km |
| 3 | 156.5 km × 156 km |
| 4 | 39.1 km × 19.5 km |
| 5 | 4.9 km × 4.9 km |
| 6 | 1.2 km × 609.4 m |
| 7 | 152.9 m × 152.4 m |
| 8 | 38.2 m × 19 m |
| 9 | 4.8 m × 4.8 m |
| 10 | 1.2 m × 59.5 cm |
| 11 | 14.9 cm × 14.9 cm |
| 12 | 3.7 cm × 1.9 cm |

Other geo cell geometries can include hexagonal tiling, triangular tiling, and/or any other suitable geometric shape tiling. For example, the H3 geospatial indexing system can be a multi-precision hexagonal tiling of a sphere (e.g., the Earth) indexed with hierarchical linear indexes.

In another aspect, geo cells are a hierarchical decomposition of a sphere (such as the Earth) into representations of regions or points based a Hilbert curve (e.g., the S2 hierarchy or other hierarchies). Regions/points of the sphere can be projected into a cube and each face of the cube includes a quad-tree where the sphere point is projected into. After that, transformations can be applied and the space discretized. The geo cells are then enumerated on a Hilbert Curve (a space-filling curve that converts multiple dimensions into one dimension and preserves the approximate locality).

Due to the hierarchical nature of geo cells, any signal, event, entity, etc., associated with a geo cell of a specified precision is by default associated with any less precise geo cells that contain the geo cell. For example, if a signal is associated with a geo cell of precision 9, the signal is by default also associated with corresponding geo cells of precisions 1, 2, 3, 4, 5, 6, 7, and 8. Similar mechanisms are applicable to other tiling and geo cell arrangements. For example, S2 has a cell level hierarchy ranging from level zero (85,011,012 km²) to level 30 (between 0.48 cm² to 0.96 cm²).

Signal Ingestion and Normalization

Signal ingestion modules can ingest a variety of raw structured and/or raw unstructured signals on an on going basis and in essentially real-time. Raw signals can include social posts, live broadcasts, traffic camera feeds, other camera feeds (e.g., from other public cameras or from CCTV cameras), listening device feeds, 911 calls, weather data, planned events, IoT device data, crowd sourced traffic and road information, satellite data, air quality sensor data, smart city sensor data, public radio communication (e.g., among first responders and/or dispatchers, between air traffic controllers and pilots), subscription data services, etc.

Raw signals can include different data media types and different data formats, including social signals, Web signals, and streaming signals. Data media types can include audio, video, image, and text. Different formats can include text in XML, text in JavaScript Object Notation (JSON), text in RSS feed, plain text, video stream in Dynamic Adaptive Streaming over HTTP (DASH), video stream in HTTP Live Streaming (HLS), video stream in Real-Time Messaging Protocol (RTMP), other Multipurpose Internet Mail Extensions (MIME) types, etc. Handling different types and formats of data introduces inefficiencies into subsequent event detection processes, including when determining if different signals relate to the same event.

Accordingly, signal ingestion modules can normalize (e.g., prepare or pre-process) raw signals into normalized signals to increase efficiency and effectiveness of subsequent computing activities, such as, event detection, event notification, etc., that utilize the normalized signals. For example, signal ingestion modules can normalize raw signals into normalized signals having a Time, Location, and Context (TLC) dimensions. An event detection infrastructure can use the Time, Location, and Content dimensions to more efficiently and effectively detect events.

A Time (T) dimension can include a time of origin or alternatively a “event time” of a signal. A Location (L) dimension can include a location anywhere across a geographic area, such as, a country (e.g., the United States), a State, a defined area, an impacted area, an area defined by a geo cell, an address, etc.

A Context (C) dimension indicates circumstances surrounding formation/origination of a raw signal in terms that facilitate understanding and assessment of the raw signal. The Context (C) dimension of a raw signal can be derived from express as well as inferred signal features of the raw signal.

Per signal type and signal content, different normalization modules can be used to extract, derive, infer, etc. Time, Location, and Context dimensions from/for a raw signal. For example, one set of normalization modules can be configured to extract/derive/infer Time, Location and Context dimensions from/for social signals. Another set of normalization modules can be configured to extract/derive/infer Time, Location and Context dimensions from/for Web signals. A further set of normalization modules can be configured to extract/derive/infer Time, Location and Context dimensions from/for streaming signals.

Normalization modules for extracting/deriving/inferring Time, Location, and Context dimensions can include text processing modules, NLP modules, image processing modules, video processing modules, etc. The modules can be used to extract/derive/infer data representative of Time, Location, and Context dimensions for a signal. Time, Location, and Context dimensions for a signal can be extracted/derived/inferred from metadata and/or content of the signal.

For example, NLP modules can analyze metadata and content of a sound clip to identify a time, location, and keywords (e.g., fire, shooter, etc.). An acoustic listener can also interpret the meaning of sounds in a sound clip (e.g., a gunshot, vehicle collision, etc.) and convert to relevant context. Live acoustic listeners can determine the distance and direction of a sound. Similarly, image processing modules can analyze metadata and pixels in an image to identify a time, location and keywords (e.g., fire, shooter, etc.). Image processing modules can also interpret the meaning of parts of an image (e.g., a person holding a gun, flames, a store logo, etc.) and convert to relevant context. Other modules can perform similar operations for other types of content including text and video.

Per signal type, each set of normalization modules can differ but may include at least some similar modules or may share some common modules. For example, similar (or the same) image analysis modules can be used to extract named entities from social signal images and public camera feeds. Likewise, similar (or the same) NLP modules can be used to extract named entities from social signal text and web text.

In some aspects, an ingested signal includes sufficient expressly defined time, location, and context information upon ingestion. The expressly defined time, location, and context information is used to determine Time, Location, and Context dimensions for the ingested signal. In other aspects, an ingested signal lacks expressly defined location information or expressly defined location information is insufficient (e.g., lacks precision) upon ingestion. In these other aspects, Location dimension or additional Location dimension can be inferred from features of an ingested signal and/or through references to other data sources. In further aspects, an ingested signal lacks expressly defined context information or expressly defined context information is insufficient (e.g., lacks precision) upon ingestion. In these further aspects, Context dimension or additional Context dimension can be inferred from features of an ingested signal and/or through reference to other data sources.

In further aspects, time information may not be included, or included time information may not be given with high enough precision and Time dimension is inferred. For example, a user may post an image to a social network which had been taken some indeterminate time earlier.

Normalization modules can use named entity recognition and reference to a geo cell database to infer Location dimension. Named entities can be recognized in text, images, video, audio, or sensor data. The recognized named entities can be compared to named entities in geo cell entries. Matches indicate possible signal origination in a geographic area defined by a geo cell.

As such, a normalized signal can include a Time dimension, a Location dimension, a Context dimension (e.g., single source probabilities and probability details), a signal type, a signal source, and content.

A single source probability can be calculated by single source classifiers (e.g., machine learning models, artificial intelligence, neural networks, statistical models, etc.) that consider hundreds, thousands, or even more signal features (dimensions) of a signal. Single source classifiers can be based on binary models and/or multi-class models.

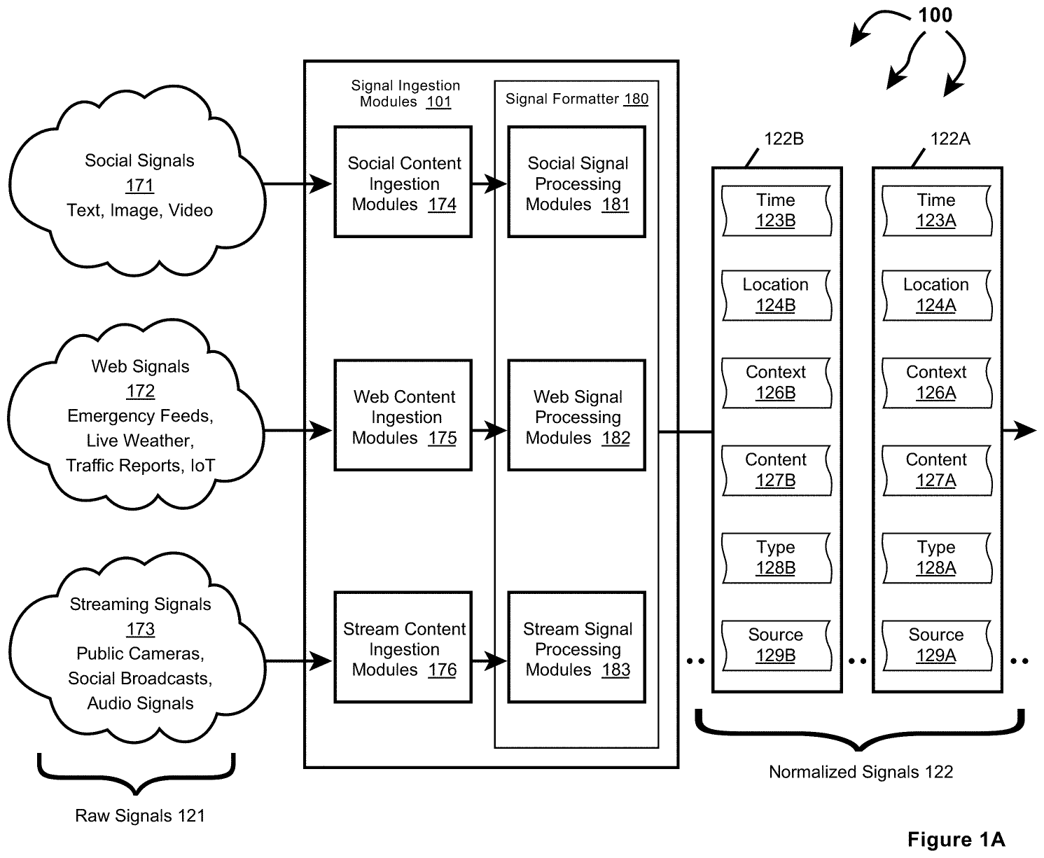

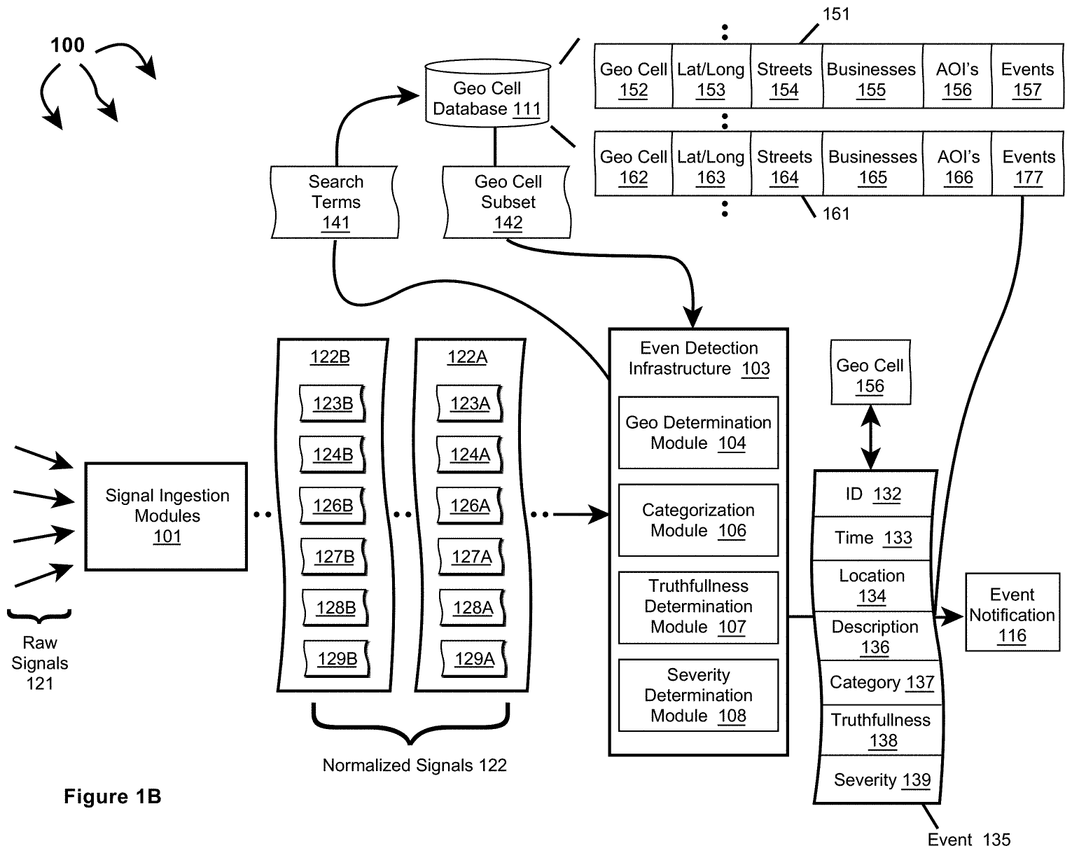

FIG. 1A depicts part of computer architecture 100 that facilitates ingesting and normalizing signals. As depicted, computer architecture 100 includes signal ingestion modules 101, social signals 171, Web signals 172, and streaming signals 173. Signal ingestion modules 101, social signals 171, Web signals 172, and streaming signals 173 can be connected to (or be part of) a network, such as, for example, a system bus, a Local Area Network (“LAN”), a Wide Area Network (“WAN”), and even the Internet. Accordingly, signal ingestion modules 101, social signals 171, Web signals 172, and streaming signals 173 as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Signal ingestion module(s) 101 can ingest raw signals 121, including social signals 171, web signals 172, and streaming signals 173, on an on going basis and in essentially real-time. Raw signals 121 can include social posts, recorded videos, streaming videos, traffic camera feeds, other camera feeds, listening device feeds, 911 calls, weather data, planned events, IoT device data, crowd sourced traffic and road information, satellite data, air quality sensor data, smart city sensor data, public radio communication, subscription data service data, etc. As such, potentially thousands, millions or even billions of unique raw signals, each with unique characteristics, are can be ingested and used determine event characteristics, such as, event truthfulness, event severity, event category or categories, etc.

Signal ingestion module(s) 101 include social content ingestion modules 174, web content ingestion modules 176, stream content ingestion modules 176, and signal formatter 180. Signal formatter 180 further includes social signal processing module 181, web signal processing module 182, and stream signal processing modules 183.

For each type of signal, a corresponding ingestion module and signal processing module can interoperate to normalize the signal into a Time, Location, Context (TLC) dimensions. For example, social content ingestion modules 174 and social signal processing module 181 can interoperate to normalize social signals 171 into TLC dimensions. Similarly, web content ingestion modules 176 and web signal processing module 182 can interoperate to normalize web signals 172 into TLC dimensions. Likewise, stream content ingestion modules 176 and stream signal processing modules 183 can interoperate to normalize streaming signals 173 into TLC dimensions.

In one aspect, signal content exceeding specified size requirements (e.g., audio or video) is cached upon ingestion. Signal ingestion modules 101 include a URL or other identifier to the cached content within the context for the signal.

In one aspect, signal formatter 180 includes modules for determining a single source probability as a ratio of signals turning into events based on the following signal properties: (1) event class (e.g., fire, accident, weather, etc.), (2) media type (e.g., text, image, audio, etc.), (3) source (e.g., twitter, traffic camera, first responder radio traffic, etc.), and (4) geo type (e.g., geo cell, region, or non-geo). Probabilities can be stored in a lookup table for different combinations of the signal properties. Features of a signal can be derived and used to query the lookup table. For example, the lookup table can be queried with terms (“accident”, “image”, “twitter”, “region”). The corresponding ratio (probability) can be returned from the table.

In another aspect, signal formatter 180 includes a plurality of single source classifiers (e.g., artificial intelligence, machine learning modules, neural networks, etc.). Each single source classifier can consider hundreds, thousands, or even more signal features (dimensions) of a signal. Signal features of a signal can be derived and submitted to a signal source classifier. The single source classifier can return a probability that a signal indicates a type of event. Single source classifiers can be binary classifiers or multi-source classifiers.

Raw classifier output can be adjusted to more accurately represent a probability that a signal is a “true positive”. For example, 1,000 signals whose raw classifier output is 0.9 may include 80% as true positives. Thus, probability can be adjusted to 0.8 to reflect true probability of the signal being a true positive. “Calibration” can be done in such a way that for any “calibrated score” this score reflects the true probability of a true positive outcome.

Signal ingestion modules 101 can insert one or more single source probabilities and corresponding probability details into a normalized signal to represent a Context (C) dimension. Probability details can indicate a probabilistic model and features used to calculate the probability. In one aspect, a probabilistic model and signal features are contained in a hash field.

Signal ingestion modules 101 can access “transdimensionality” transformations structured and defined in a “TLC” dimensional model. Signal ingestion modules 101 can apply the “transdimensionality” transformations to generic source data in raw signals to re-encode the source data into normalized data having lower dimensionality. Dimensionality reduction can include reducing dimensionality (e.g., hundreds, thousands, or even more signal features (dimensions)) of a raw signal into a normalized signal including a T vector, an L vector, and a C vector. At lower dimensionality, the complexity of measuring “distances” between dimensional vectors across different normalized signals is reduced.

Thus, in general, any received raw signals can be normalized into normalized signals including a Time (T) dimension, a Location (L) dimension, a Context (C) dimension, signal source, signal type, and content. Signal ingestion modules 101 can send normalized signals 122 to event detection infrastructure 103.

For example, signal ingestion modules 101 can send normalized signal 122A, including time 123A, location 124A, context 126A, content 127A, type 128A, and source 129A to event detection infrastructure 103. Similarly, signal ingestion modules 101 can send normalized signal 122B, including time 123B, location 124B, context 126B, content 127B, type 128B, and source 129B to event detection infrastructure 103.

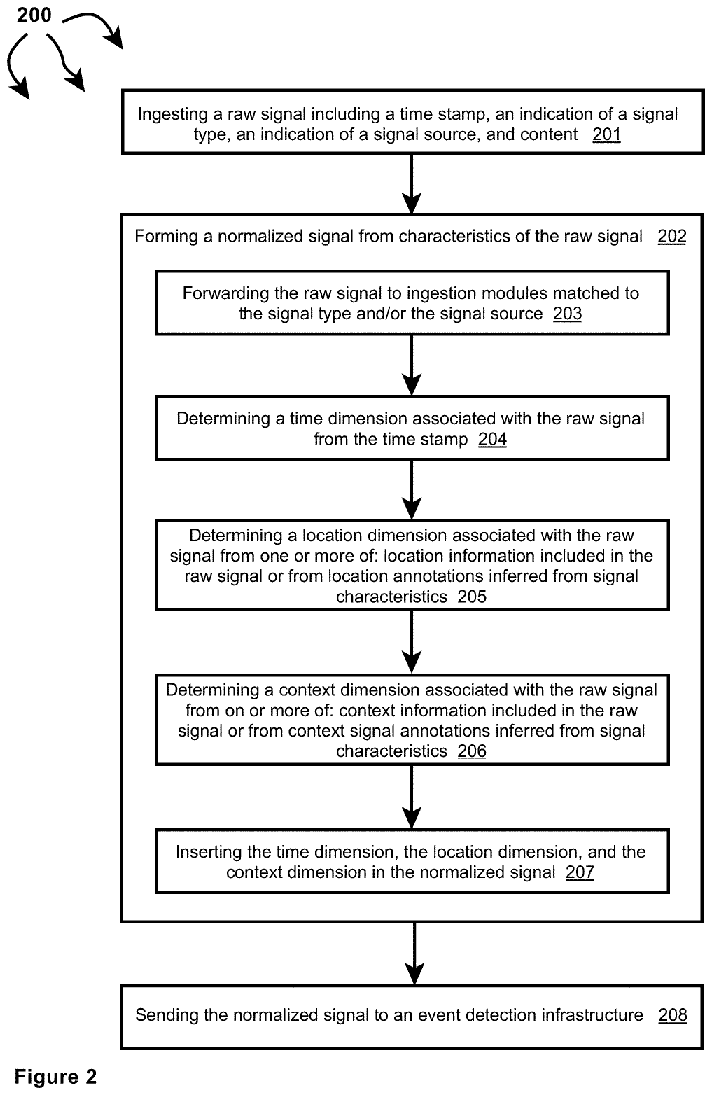

FIG. 2 illustrates a flow chart of an example method 200 for normalizing ingested signals. Method 200 will be described with respect to the components and data in computer architecture 100.

Method 200 includes ingesting a raw signal including a time stamp, an indication of a signal type, an indication of a signal source, and content (201). For example, signal ingestion modules 101 can ingest a raw signal 121 from one of: social signals 171, web signals 172, or streaming signals 173.

Method 200 includes forming a normalized signal from characteristics of the raw signal (202). For example, signal ingestion modules 101 can form a normalized signal 122A from the ingested raw signal 121.

Forming a normalized signal includes forwarding the raw signal to ingestion modules matched to the signal type and/or the signal source (203). For example, if ingested raw signal 121 is from social signals 171, raw signal 121 can be forwarded to social content ingestion modules 174 and social signal processing modules 181. If ingested raw signal 121 is from web signals 172, raw signal 121 can be forwarded to web content ingestion modules 175 and web signal processing modules 182. If ingested raw signal 121 is from streaming signals 173, raw signal 121 can be forwarded to streaming content ingestion modules 176 and streaming signal processing modules 183.

Forming a normalized signal includes determining a time dimension associated with the raw signal from the time stamp (204). For example, signal ingestion modules 101 can determine time 123A from a time stamp in ingested raw signal 121.

Forming a normalized signal includes determining a location dimension associated with the raw signal from one or more of: location information included in the raw signal or from location annotations inferred from signal characteristics (205). For example, signal ingestion modules 101 can determine location 124A from location information included in raw signal 121 or from location annotations derived from characteristics of raw signal 121 (e.g., signal source, signal type, signal content).

Forming a normalized signal includes determining a context dimension associated with the raw signal from one or more of: context information included in the raw signal or from context signal annotations inferred from signal characteristics (206). For example, signal ingestion modules 101 can determine context 126A from context information included in raw signal 121 or from context annotations derived from characteristics of raw signal 121 (e.g., signal source, signal type, signal content).

Forming a normalized signal includes inserting the time dimension, the location dimension, and the context dimension in the normalized signal (207). For example, signal ingestion modules 101 can insert time 123A, location 124A, and context 126A in normalized signal 122. Method 200 includes sending the normalized signal to an event detection infrastructure (208). For example, signal ingestion modules 101 can send normalized signal 122A to event detection infrastructure 103.

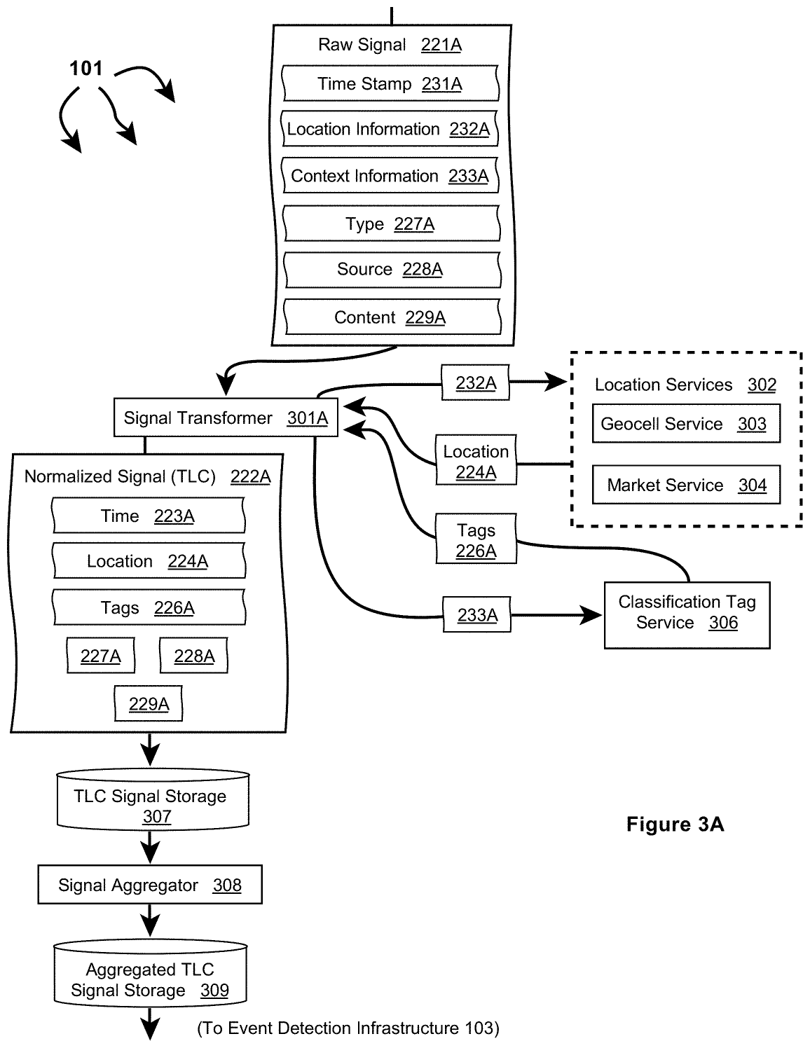

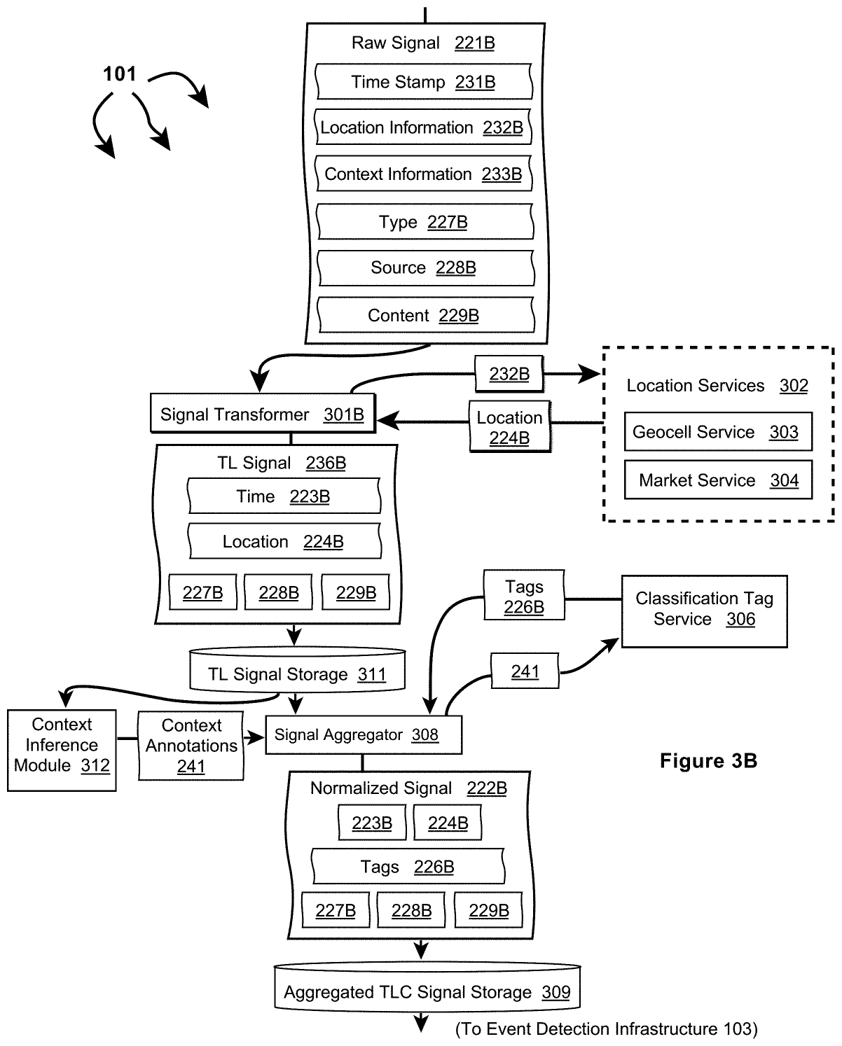

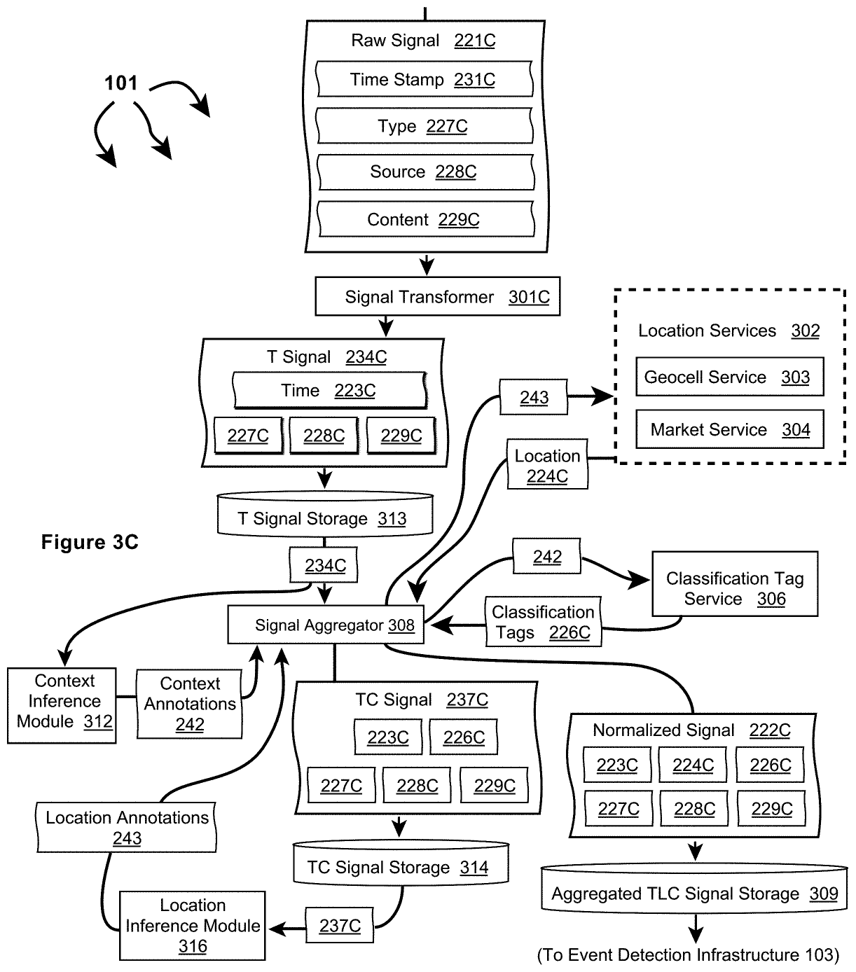

FIGS. 3A, 3B, and 3C depict other example components that can be included in signal ingestion modules 101. Signal ingestion modules 101 can include signal transformers for different types of signals including signal transformer 301A (for TLC signals), signal transformer 301B (for TL signals), and signal transformer 301C (for T signals). In one aspect, a single module combines the functionality of multiple different signal transformers.

Signal ingestion modules 101 can also include location services 302, classification tag service 306, signal aggregator 308, context inference module 312, and location inference module 316. Location services 302, classification tag service 306, signal aggregator 308, context inference module 312, and location inference module 316 or parts thereof can interoperate with and/or be integrated into any of ingestion modules 174, web content ingestion modules 176, stream content ingestion modules 176, social signal processing module 181, web signal processing module 182, and stream signal processing modules 183. Location services 302, classification tag service 306, signal aggregator 308, context inference module 312, and location inference module 316 can interoperate to implement “transdimensionality” transformations to reduce raw signal dimensionality into normalized TLC signals.

Signal ingestion modules 101 can also include storage for signals in different stages of normalization, including TLC signal storage 307, TL signal storage 311, T signal storage 313, TC signal storage 314, and aggregated TLC signal storage 309. In one aspect, data ingestion modules 101 implement a distributed messaging system. Each of signal storage 307, 309, 311, 313, and 314 can be implemented as a message container (e.g., a topic) associated with a type of message.

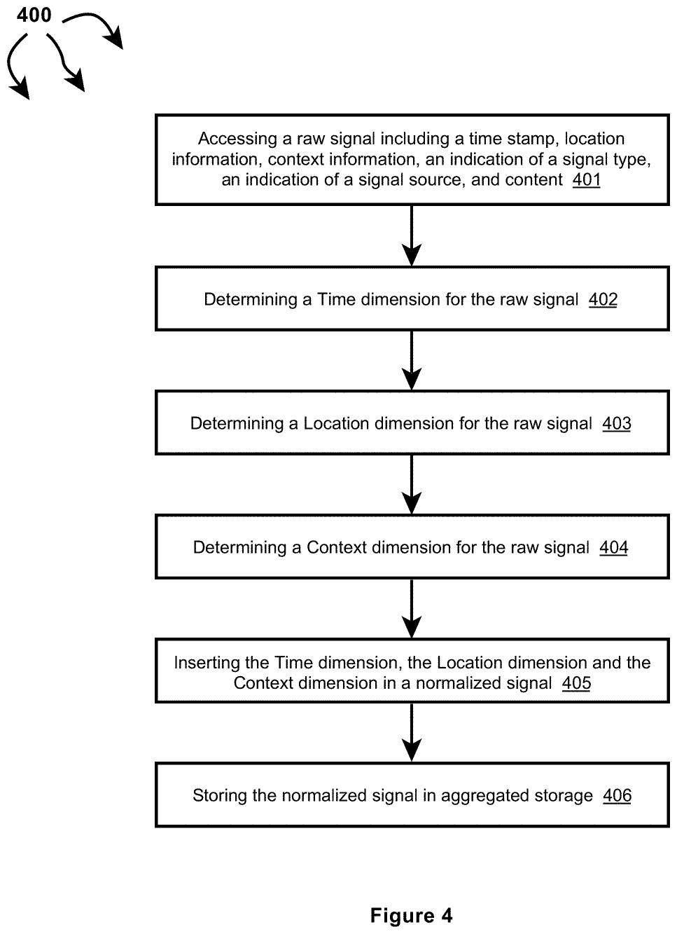

FIG. 4 illustrates a flow chart of an example method 400 for normalizing an ingested signal including time information, location information, and context information. Method 400 will be described with respect to the components and data in FIG. 3A.

Method 400 includes accessing a raw signal including a time stamp, location information, context information, an indication of a signal type, an indication of a signal source, and content (401). For example, signal transformer 301A can access raw signal 221A. Raw signal 221A includes timestamp 231A, location information 232A (e.g., lat/lon, GPS coordinates, etc.), context information 233A (e.g., text expressly indicating a type of event), signal type 227A (e.g., social media, 911 communication, traffic camera feed, etc.), signal source 228A (e.g., Facebook, twitter, Waze, etc.), and signal content 229A (e.g., one or more of: image, video, text, keyword, locale, etc.).

Method 400 includes determining a Time dimension for the raw signal (402). For example, signal transformer 301A can determine time 223A from timestamp 231A.

Method 400 includes determining a Location dimension for the raw signal (403). For example, signal transformer 301A sends location information 232A to location services 302. Geo cell service 303 can identify a geo cell corresponding to location information 232A. Market service 304 can identify a designated market area (DMA) corresponding to location information 232A. Location services 302 can include the identified geo cell and/or DMA in location 224A. Location services 302 return location 224A to signal transformer 301.

Method 400 includes determining a Context dimension for the raw signal (404). For example, signal transformer 301A sends context information 233A to classification tag service 306. Classification tag service 306 identifies one or more classification tags 226A (e.g., fire, police presence, accident, natural disaster, etc.) from context information 233A. Classification tag service 306 returns classification tags 226A to signal transformer 301A.

Method 400 includes inserting the Time dimension, the Location dimension, and the Context dimension in a normalized signal (405). For example, signal transformer 301A can insert time 223A, location 224A, and tags 226A in normalized signal 222A (a TLC signal). Method 400 includes storing the normalized signal in signal storage (406). For example, signal transformer 301A can store normalized signal 222A in TLC signal storage 307. (Although not depicted, timestamp 231A, location information 232A, and context information 233A can also be included (or remain) in normalized signal 222A).

Method 400 includes storing the normalized signal in aggregated storage (406). For example, signal aggregator 308 can aggregate normalized signal 222A along with other normalized signals determined to relate to the same event. In one aspect, signal aggregator 308 forms a sequence of signals related to the same event. Signal aggregator 308 stores the signal sequence, including normalized signal 222A, in aggregated TLC storage 309 and eventually forwards the signal sequence to event detection infrastructure 103.

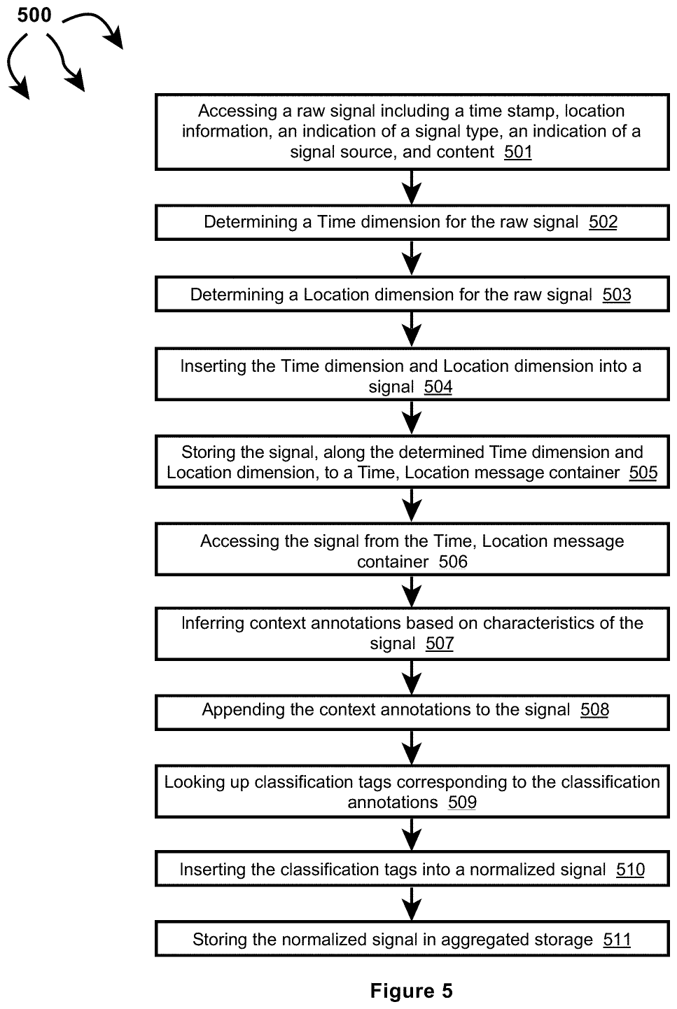

FIG. 5 illustrates a flow chart of an example method 500 for normalizing an ingested signal including time information and location information. Method 500 will be described with respect to the components and data in FIG. 3B.

Method 500 includes accessing a raw signal including a time stamp, location information, an indication of a signal type, an indication of a signal source, and content (501). For example, signal transformer 301B can access raw signal 221B. Raw signal 221B includes timestamp 231B, location information 232B (e.g., lat/lon, GPS coordinates, etc.), signal type 227B (e.g., social media, 911 communication, traffic camera feed, etc.), signal source 228B (e.g., Facebook, twitter, Waze, etc.), and signal content 229B (e.g., one or more of: image, video, audio, text, keyword, locale, etc.).

Method 500 includes determining a Time dimension for the raw signal (502). For example, signal transformer 301B can determine time 223B from timestamp 231B.

Method 500 includes determining a Location dimension for the raw signal (503). For example, signal transformer 301B sends location information 232B to location services 302. Geo cell service 303 can be identify a geo cell corresponding to location information 232B. Market service 304 can identify a designated market area (DMA) corresponding to location information 232B. Location services 302 can include the identified geo cell and/or DMA in location 224B. Location services 302 returns location 224B to signal transformer 301.

Method 500 includes inserting the Time dimension and Location dimension into a signal (504). For example, signal transformer 301B can insert time 223B and location 224B into TL signal 236B. (Although not depicted, timestamp 231B and location information 232B can also be included (or remain) in TL signal 236B). Method 500 includes storing the signal, along with the determined Time dimension and Location dimension, to a Time, Location message container (505). For example, signal transformer 301B can store TL signal 236B to TL signal storage 311. Method 500 includes accessing the signal from the Time, Location message container (506). For example, signal aggregator 308 can access TL signal 236B from TL signal storage 311.

Method 500 includes inferring context annotations based on characteristics of the signal (507). For example, context inference module 312 can access TL signal 236B from TL signal storage 311. Context inference module 312 can infer context annotations 241 from characteristics of TL signal 236B, including one or more of: time 223B, location 224B, type 227B, source 228B, and content 229B. In one aspect, context inference module 312 includes one or more of: NLP modules, audio analysis modules, image analysis modules, video analysis modules, etc. Context inference module 312 can process content 229B in view of time 223B, location 224B, type 227B, source 228B, to infer context annotations 241 (e.g., using machine learning, artificial intelligence, neural networks, machine classifiers, etc.). For example, if content 229B is an image that depicts flames and a fire engine, context inference module 312 can infer that content 229B is related to a fire. Context inference 312 module can return context annotations 241 to signal aggregator 308.

Method 500 includes appending the context annotations to the signal (508). For example, signal aggregator 308 can append context annotations 241 to TL signal 236B. Method 500 includes looking up classification tags corresponding to the classification annotations (509). For example, signal aggregator 308 can send context annotations 241 to classification tag service 306. Classification tag service 306 can identify one or more classification tags 226B (a Context dimension) (e.g., fire, police presence, accident, natural disaster, etc.) from context annotations 241. Classification tag service 306 returns classification tags 226B to signal aggregator 308.

Method 500 includes inserting the classification tags in a normalized signal (510). For example, signal aggregator 308 can insert tags 226B (a Context dimension) into normalized signal 222B (a TLC signal). Method 500 includes storing the normalized signal in aggregated storage (511). For example, signal aggregator 308 can aggregate normalized signal 222B along with other normalized signals determined to relate to the same event. In one aspect, signal aggregator 308 forms a sequence of signals related to the same event. Signal aggregator 308 stores the signal sequence, including normalized signal 222B, in aggregated TLC storage 309 and eventually forwards the signal sequence to event detection infrastructure 103. (Although not depicted, timestamp 231B, location information 232C, and context annotations 241 can also be included (or remain) in normalized signal 222B).

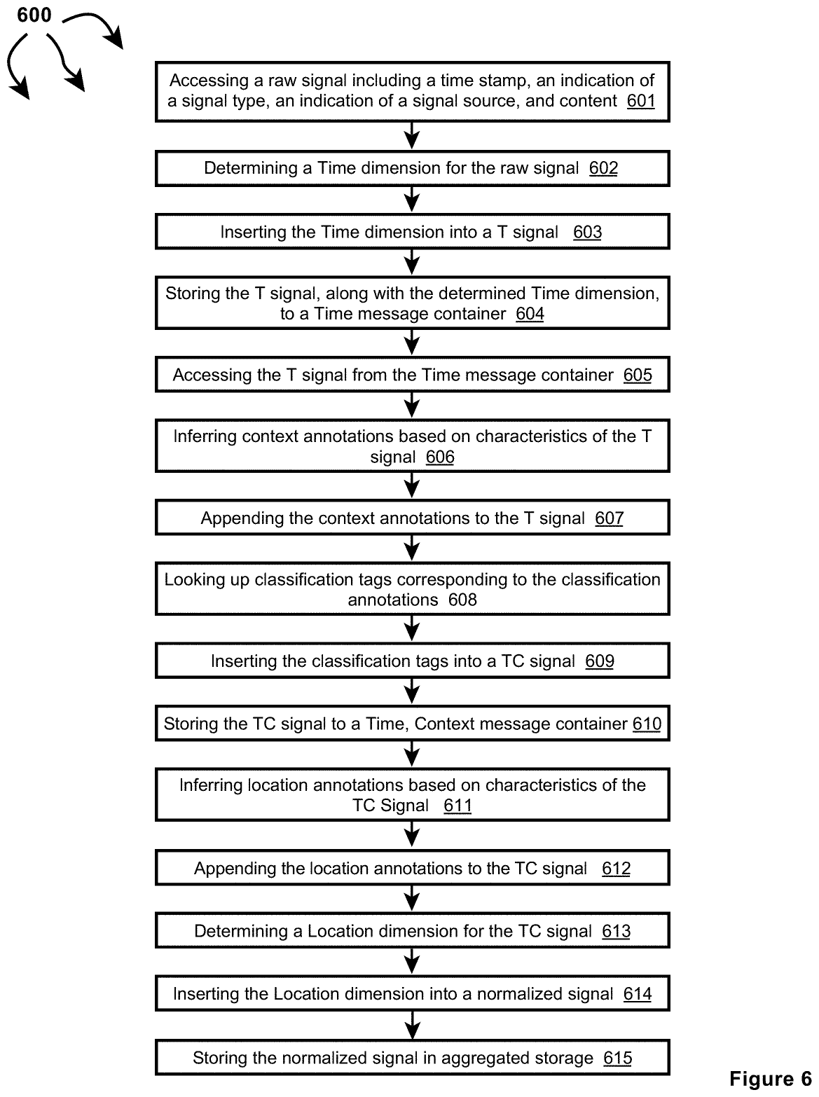

FIG. 6 illustrates a flow chart of an example method 600 for normalizing an ingested signal including time information and location information. Method 600 will be described with respect to the components and data in FIG. 3C.

Method 600 includes accessing a raw signal including a time stamp, an indication of a signal type, an indication of a signal source, and content (601). For example, signal transformer 301C can access raw signal 221C. Raw signal 221C includes timestamp 231C, signal type 227C (e.g., social media, 911 communication, traffic camera feed, etc.), signal source 228C (e.g., Facebook, twitter, Waze, etc.), and signal content 229C (e.g., one or more of: image, video, text, keyword, locale, etc.).

Method 600 includes determining a Time dimension for the raw signal (602). For example, signal transformer 301C can determine time 223C from timestamp 231C. Method 600 includes inserting the Time dimension into a T signal (603). For example, signal transformer 301C can insert time 223C into T signal 234C. (Although not depicted, timestamp 231C can also be included (or remain) in T signal 234C).

Method 600 includes storing the T signal, along with the determined Time dimension, to a Time message container (604). For example, signal transformer 301C can store T signal 236C to T signal storage 313. Method 600 includes accessing the T signal from the Time message container (605). For example, signal aggregator 308 can access T signal 234C from T signal storage 313.

Method 600 includes inferring context annotations based on characteristics of the T signal (606). For example, context inference module 312 can access T signal 234C from T signal storage 313. Context inference module 312 can infer context annotations 242 from characteristics of T signal 234C, including one or more of: time 223C, type 227C, source 228C, and content 229C. As described, context inference module 312 can include one or more of: NLP modules, audio analysis modules, image analysis modules, video analysis modules, etc. Context inference module 312 can process content 229C in view of time 223C, type 227C, source 228C, to infer context annotations 242 (e.g., using machine learning, artificial intelligence, neural networks, machine classifiers, etc.). For example, if content 229C is a video depicting two vehicles colliding on a roadway, context inference module 312 can infer that content 229C is related to an accident. Context inference 312 module can return context annotations 242 to signal aggregator 308.

Method 600 includes appending the context annotations to the T signal (607). For example, signal aggregator 308 can append context annotations 242 to T signal 234C. Method 600 includes looking up classification tags corresponding to the classification annotations (608). For example, signal aggregator 308 can send context annotations 242 to classification tag service 306. Classification tag service 306 can identify one or more classification tags 226C (a Context dimension) (e.g., fire, police presence, accident, natural disaster, etc.) from context annotations 242. Classification tag service 306 returns classification tags 226C to signal aggregator 308.

Method 600 includes inserting the classification tags into a TC signal (609). For example, signal aggregator 308 can insert tags 226C into TC signal 237C. Method 600 includes storing the TC signal to a Time, Context message container (610). For example, signal aggregator 308 can store TC signal 237C in TC signal storage 314. (Although not depicted, timestamp 231C and context annotations 242 can also be included (or remain) in normalized signal 237C).

Method 600 includes inferring location annotations based on characteristics of the TC signal (611). For example, location inference module 316 can access TC signal 237C from TC signal storage 314. Location inference module 316 can include one or more of: NLP modules, audio analysis modules, image analysis modules, video analysis modules, etc. Location inference module 316 can process content 229C in view of time 223C, type 227C, source 228C, and classification tags 226C (and possibly context annotations 242) to infer location annotations 243 (e.g., using machine learning, artificial intelligence, neural networks, machine classifiers, etc.). For example, if content 229C is a video depicting two vehicles colliding on a roadway, the video can include a nearby street sign, business name, etc. Location inference module 316 can infer a location from the street sign, business name, etc. Location inference module 316 can return location annotations 243 to signal aggregator 308.

Method 600 includes appending the location annotations to the TC signal with location annotations (612). For example, signal aggregator 308 can append location annotations 243 to TC signal 237C. Method 600 determining a Location dimension for the TC signal (613). For example, signal aggregator 308 can send location annotations 243 to location services 302. Geo cell service 303 can identify a geo cell corresponding to location annotations 243. Market service 304 can identify a designated market area (DMA) corresponding to location annotations 243. Location services 302 can include the identified geo cell and/or DMA in location 224C. Location services 302 returns location 224C to signal aggregation services 308.

Method 600 includes inserting the Location dimension into a normalized signal (614). For example, signal aggregator 308 can insert location 224C into normalized signal 222C. Method 600 includes storing the normalized signal in aggregated storage (615). For example, signal aggregator 308 can aggregate normalized signal 222C along with other normalized signals determined to relate to the same event. In one aspect, signal aggregator 308 forms a sequence of signals related to the same event. Signal aggregator 308 stores the signal sequence, including normalized signal 222C, in aggregated TLC storage 309 and eventually forwards the signal sequence to event detection infrastructure 103. (Although not depicted, timestamp 231B, context annotations 241, and location annotations 24, can also be included (or remain) in normalized signal 222B).

In another aspect, a Location dimension is determined prior to a Context dimension when a T signal is accessed. A Location dimension (e.g., geo cell and/or DMA) and/or location annotations are used when inferring context annotations.

Accordingly, location services 302 can identify a geo cell and/or DMA for a signal from location information in the signal and/or from inferred location annotations. Similarly, classification tag service 306 can identify classification tags for a signal from context information in the signal and/or from inferred context annotations.

Signal aggregator 308 can concurrently handle a plurality of signals in a plurality of different stages of normalization. For example, signal aggregator 308 can concurrently ingest and/or process a plurality T signals, a plurality of TL signals, a plurality of TC signals, and a plurality of TLC signals. Accordingly, aspects of the invention facilitate acquisition of live, ongoing forms of data into an event detection system with signal aggregator 308 acting as an “air traffic controller” of live data. Signals from multiple sources of data can be aggregated and normalized for a common purpose (e.g., of event detection). Data ingestion, event detection, and event notification can process data through multiple stages of logic with concurrency.

As such, a unified interface can handle incoming signals and content of any kind. The interface can handle live extraction of signals across dimensions of time, location, and context. In some aspects, heuristic processes are used to determine one or more dimensions. Acquired signals can include text and images as well as live-feed binaries, including live media in audio, speech, fast still frames, video streams, etc.

Signal normalization enables the world's live signals to be collected at scale and analyzed for detection and validation of live events happening globally. A data ingestion and event detection pipeline aggregates signals and combines detections of various strengths into truthful events. Thus, normalization increases event detection efficiency facilitating event detection closer to “live time” or at “moment zero”.

Event Detection

Turning back to FIG. 1B, computer architecture 100 also includes components that facilitate detecting events. As depicted, computer architecture 100 includes geo cell database 111 and event notification 116. Geo cell database 111 and event notification 116 can be connected to (or be part of) a network with signal ingestion modules 101 and event detection infrastructure 103. As such, geo cell database 111 and even notification 116 can create and exchange message related data over the network.

As described, in general, on an ongoing basis, concurrently with signal ingestion (and also essentially in real-time), event detection infrastructure 103 detects different categories of (planned and unplanned) events (e.g., fire, police response, mass shooting, traffic accident, natural disaster, storm, active shooter, concerts, protests, etc.) in different locations (e.g., anywhere across a geographic area, such as, the United States, a State, a defined area, an impacted area, an area defined by a geo cell, an address, etc.), at different times from Time, Location, and Context dimensions included in normalized signals. Since, normalized signals are normalized to include Time, Location, and Context dimensions, event detection infrastructure 103 can handle normalized signals in a more uniform manner increasing event detection efficiency and effectiveness.

Event detection infrastructure 103 can also determine an event truthfulness, event severity, and an associated geo cell. In one aspect, a Context dimension in a normalized signal increases the efficiency and effectiveness of determining truthfulness, severity, and an associated geo cell.

Generally, an event truthfulness indicates how likely a detected event is actually an event (vs. a hoax, fake, misinterpreted, etc.). Truthfulness can range from less likely to be true to more likely to be true. In one aspect, truthfulness is represented as a numerical value, such as, for example, from 1 (less truthful) to 10 (more truthful) or as percentage value in a percentage range, such as, for example, from 0% (less truthful) to 100% (more truthful). Other truthfulness representations are also possible. For example, truthfulness can be a dimension or represented by one or more vectors.

Generally, an event severity indicates how severe an event is (e.g., what degree of badness, what degree of damage, etc. is associated with the event). Severity can range from less severe (e.g., a single vehicle accident without injuries) to more severe (e.g., multi vehicle accident with multiple injuries and a possible fatality). As another example, a shooting event can also range from less severe (e.g., one victim without life threatening injuries) to more severe (e.g., multiple injuries and multiple fatalities). In one aspect, severity is represented as a numerical value, such as, for example, from 1 (less severe) to 5 (more severe). Other severity representations are also possible. For example, severity can be a dimension or represented by one or more vectors.

In general, event detection infrastructure 103 can include a geo determination module including modules for processing different kinds of content including location, time, context, text, images, audio, and video into search terms. The geo determination module can query a geo cell database with search terms formulated from normalized signal content. The geo cell database can return any geo cells having matching supplemental information. For example, if a search term includes a street name, a subset of one or more geo cells including the street name in supplemental information can be returned to the event detection infrastructure.

Event detection infrastructure 103 can use the subset of geo cells to determine a geo cell associated with an event location. Events associated with a geo cell can be stored back into an entry for the geo cell in the geo cell database. Thus, over time an historical progression of events within a geo cell can be accumulated.

As such, event detection infrastructure 103 can assign an event ID, an event time, an event location, an event category, an event description, an event truthfulness, and an event severity to each detected event. Detected events can be sent to relevant entities, including to mobile devices, to computer systems, to APIs, to data storage, etc.

Event detection infrastructure 103 detects events from information contained in normalized signals 122. Event detection infrastructure 103 can detect an event from a single normalized signal 122 or from multiple normalized signals 122. In one aspect, event detection infrastructure 103 detects an event based on information contained in one or more normalized signals 122. In another aspect, event detection infrastructure 103 detects a possible event based on information contained in one or more normalized signals 122. Event detection infrastructure 103 then validates the potential event as an event based on information contained in one or more other normalized signals 122.

As depicted, event detection infrastructure 103 includes geo determination module 104, categorization module 106, truthfulness determination module 107, and severity determination module 108.

Generally, geo determination module 104 can include NLP modules, image analysis modules, etc. for identifying location information from a normalized signal. Geo determination module 104 can formulate (e.g., location) search terms 141 by using NLP modules to process audio, using image analysis modules to process images and video frames, etc. Search terms can include street addresses, building names, landmark names, location names, school names, image fingerprints, etc. Event detection infrastructure 103 can use a URL or identifier to access cached content when appropriate.

Generally, categorization module 106 can categorize a detected event into one of a plurality of different categories (e.g., fire, police response, mass shooting, traffic accident, natural disaster, storm, active shooter, concerts, protests, etc.) based on the content of normalized signals used to detect and/or otherwise related to an event.

Generally, truthfulness determination module 107 can determine the truthfulness of a detected event based on one or more of: source, type, age, and content of normalized signals used to detect and/or otherwise related to the event. Some signal types may be inherently more reliable than other signal types. For example, video from a live traffic camera feed may be more reliable than text in a social media post. Some signal sources may be inherently more reliable than others. For example, a social media account of a government agency may be more reliable than a social media account of an individual. The reliability of a signal can decay over time.

Generally, severity determination module 108 can determine the severity of a detected event based on or more of: location, content (e.g., dispatch codes, keywords, etc.), and volume of normalized signals used to detect and/or otherwise related to an event. Events at some locations may be inherently more severe than events at other locations. For example, an event at a hospital is potentially more severe than the same event at an abandoned warehouse. Event category can also be considered when determining severity. For example, an event categorized as a “Shooting” may be inherently more severe than an event categorized as “Police Presence” since a shooting implies that someone has been injured.

Geo cell database 111 includes a plurality of geo cell entries. Each geo cell entry is included in a geo cell defining an area and corresponding supplemental information about things included in the defined area. The corresponding supplemental information can include latitude/longitude, street names in the area defined by and/or beyond the geo cell, businesses in the area defined by the geo cell, other Areas of Interest (AOIs) (e.g., event venues, such as, arenas, stadiums, theaters, concert halls, etc.) in the area defined by the geo cell, image fingerprints derived from images captured in the area defined by the geo cell, and prior events that have occurred in the area defined by the geo cell. For example, geo cell entry 151 includes geo cell 152, lat/lon 153, streets 154, businesses 155, AOIs 156, and prior events 157. Each event in prior events 157 can include a location (e.g., a street address), a time (event occurrence time), an event category, an event truthfulness, an event severity, and an event description. Similarly, geo cell entry 161 includes geo cell 162, lat/lon 163, streets 164, businesses 165, AOIs 166, and prior events 167. Each event in prior events 167 can include a location (e.g., a street address), a time (event occurrence time), an event category, an event truthfulness, an event severity, and an event description.

Other geo cell entries can include the same or different (more or less) supplemental information, for example, depending on infrastructure density in an area. For example, a geo cell entry for an urban area can contain more diverse supplemental information than a geo cell entry for an agricultural area (e.g., in an empty field).

Geo cell database 111 can store geo cell entries in a hierarchical arrangement based on geo cell precision. As such, geo cell information of more precise geo cells is included in the geo cell information for any less precise geo cells that include the more precise geo cell.

Geo determination module 104 can query geo cell database 111 with search terms 141. Geo cell database 111 can identify any geo cells having supplemental information that matches search terms 141. For example, if search terms 141 include a street address and a business name, geo cell database 111 can identify geo cells having the street name and business name in the area defined by the geo cell. Geo cell database 111 can return any identified geo cells to geo determination module 104 in geo cell subset 142.

Geo determination module can use geo cell subset 142 to determine the location of event 135 and/or a geo cell associated with event 135. As depicted, event 135 includes event ID 132, time 133, location 137, description 136, category 137, truthfulness 138, and severity 139.

Event detection infrastructure 103 can also determine that event 135 occurred in an area defined by geo cell 162 (e.g., a geohash having precision of level 7 or level 9). For example, event detection infrastructure 103 can determine that location 134 is in the area defined by geo cell 162. As such, event detection infrastructure 103 can store event 135 in events 167 (i.e., historical events that have occurred in the area defined by geo cell 162).

Event detection infrastructure 103 can also send event 135 to event notification module 116. Event notification module 116 can notify one or more entities about event 135.

Segmenting Video Stream Frames

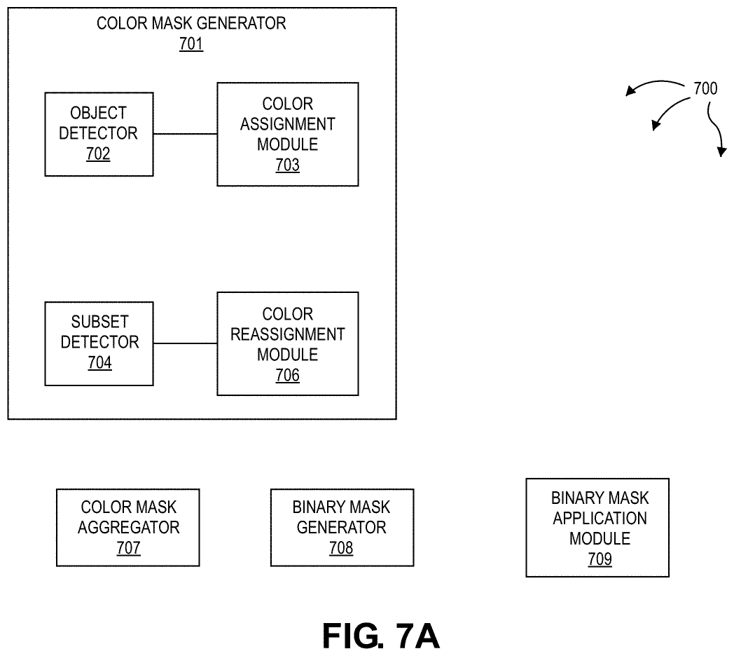

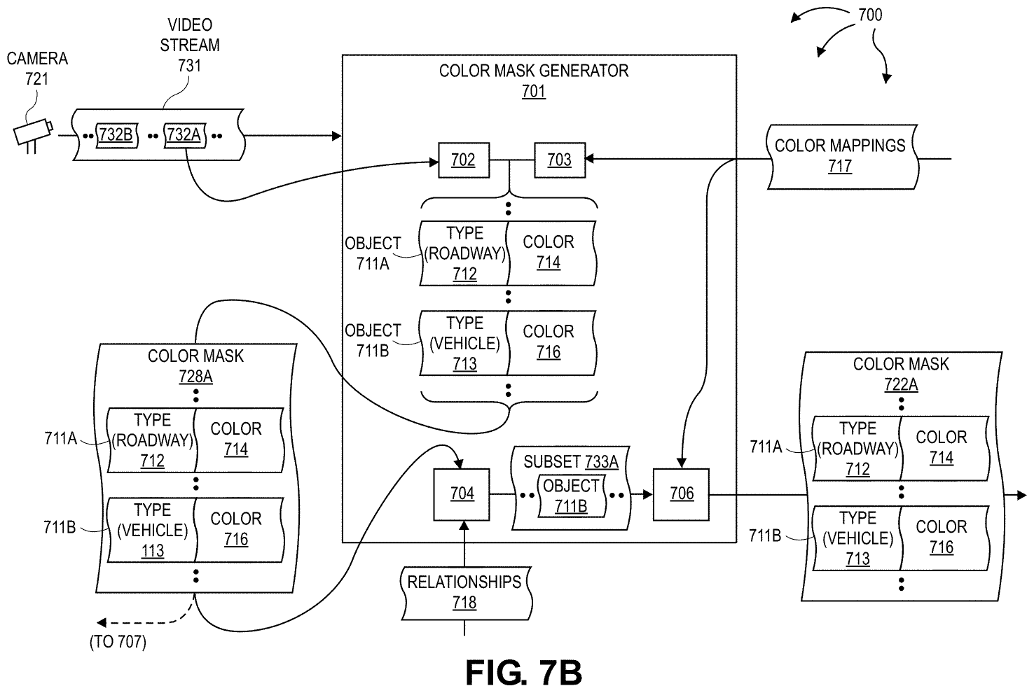

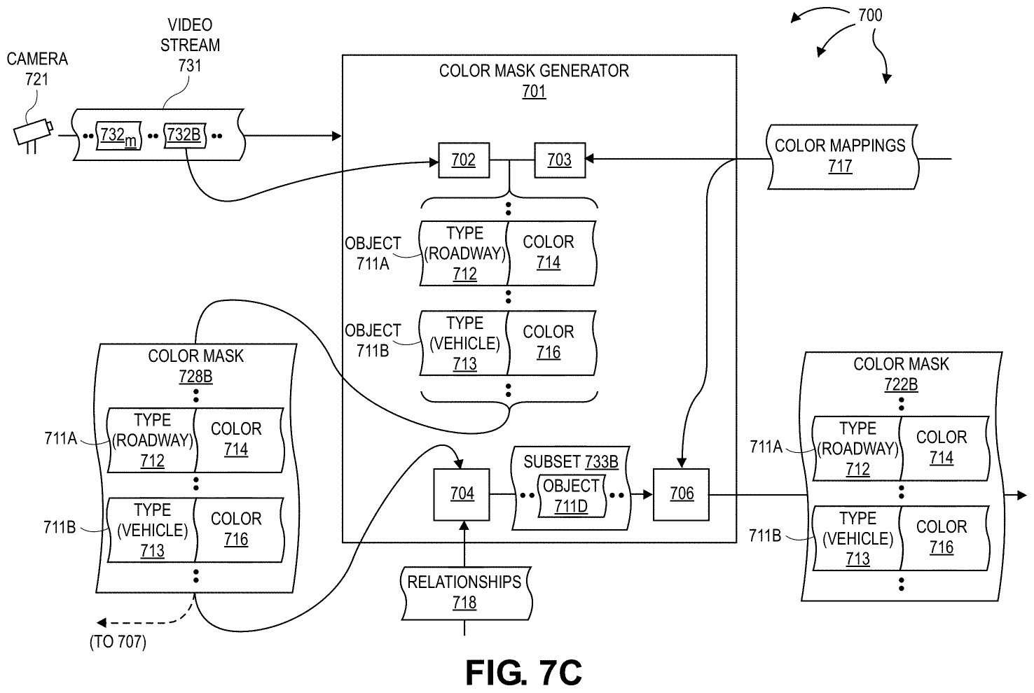

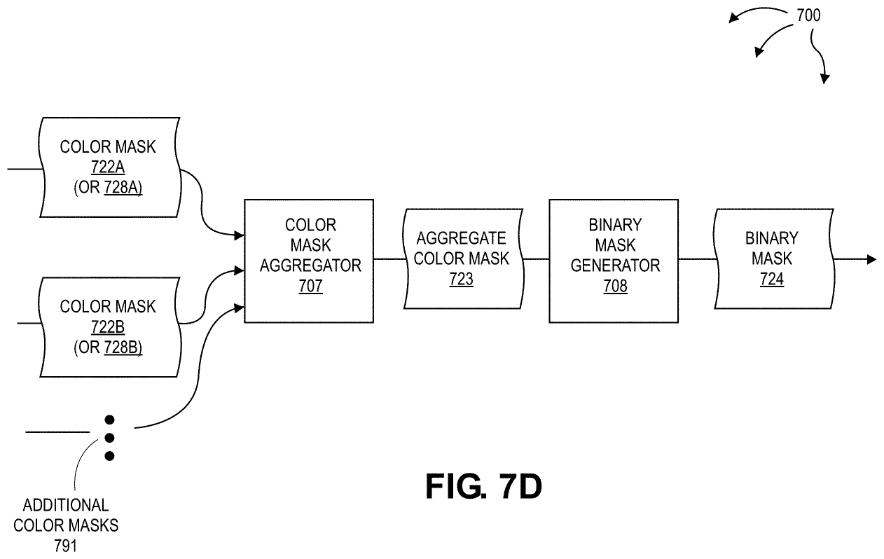

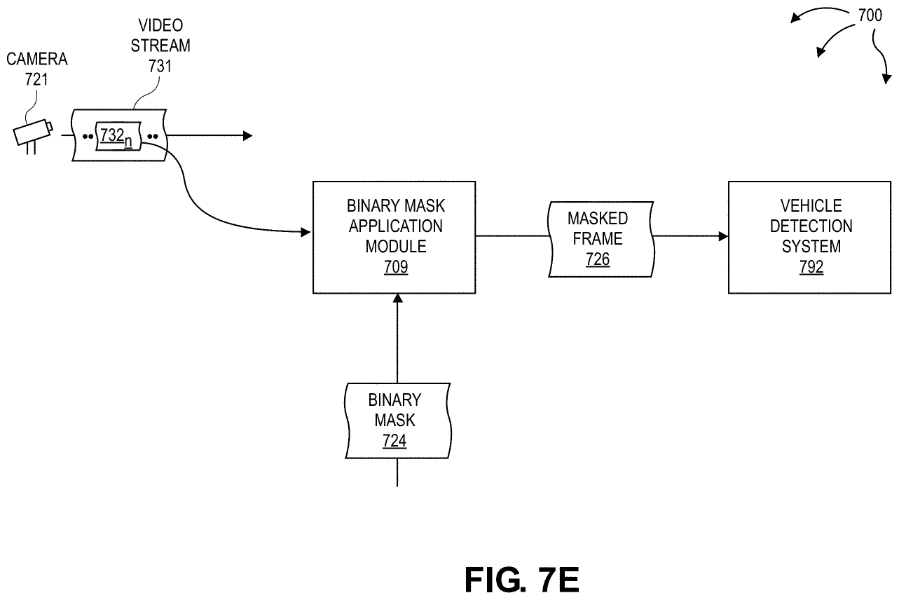

FIGS. 7A-7E depict a computer architecture 700 that facilitates segmenting video stream frames. As depicted, computer architecture 700 includes color mask generator 701, color mask aggregator 707, binary mask generator 708, and binary mask application module 709. Color mask generator 701 further includes object detector 702, color assignment module 703, subset detector 704, and color reassignment module 706.

In general, color mask generator 101 is configured to receive a video stream frame and generate a corresponding video stream frame color mask. Object detector 702 can detect object types in a video stream frame including but not limited to: roadway portions, vehicles, trees, bushes, guard rails, signs, walls, buildings, sky, etc. Each object type can be associated with a corresponding different defined color. Color assignment module 703 can assign defined colors to identified objects based on object type. For example, color assignment module 703 can assign one color to vehicles, a another color to roadway portions, a further color to the sky, etc.

Subset detector 704 can detect subsets of one object type that have a defined relationship with another object type. For example, subset detector 704 can detect one or more vehicles within a roadway portion. Color reassignment module 706 can reassign colors of an object type based on a defined relationship. For example, for any vehicles within a roadway, color reassignment module 706 can reassign a color assigned to vehicles to a color assigned to a roadway. That is, vehicles in a roadway can be assigned the same color as the roadway.

Color mask aggregator 707 can aggregate a plurality of video stream frame color masks into an aggregate (e.g., average) color mask. Binary mask generator can generate a binary mask for a video stream from an aggregate color mask. In one aspect, any pixels assigned the color of a particular object type (e.g., roadway portions) are assigned a “1” and pixels assigned colors of any other object type are assigned a “0” (absence of information).

Binary mask application module 709 can apply a binary mask to subsequent video stream frames to mask out objects other than the particular object type (e.g., that is more likely to be relevant during further processing). For example, a binary mask can be applied to a video stream frame to mask out objects other than roadways. Subsequent processing of the video stream frame can be limited to the particular object type. (e.g., to the roadway). As such, resources are not consumed processing parts of video stream frames unlikely to yield meaningful (e.g., relevant) results.

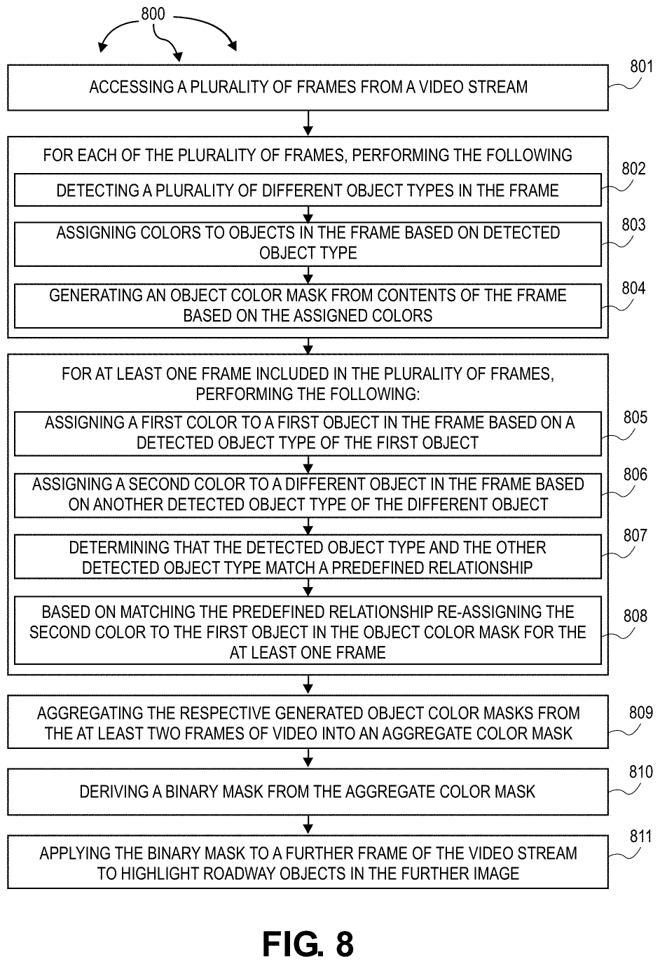

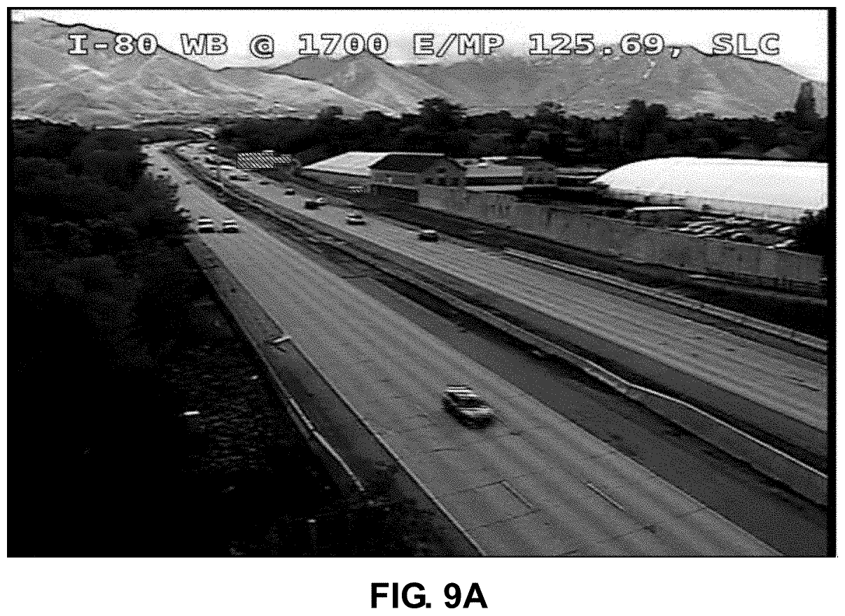

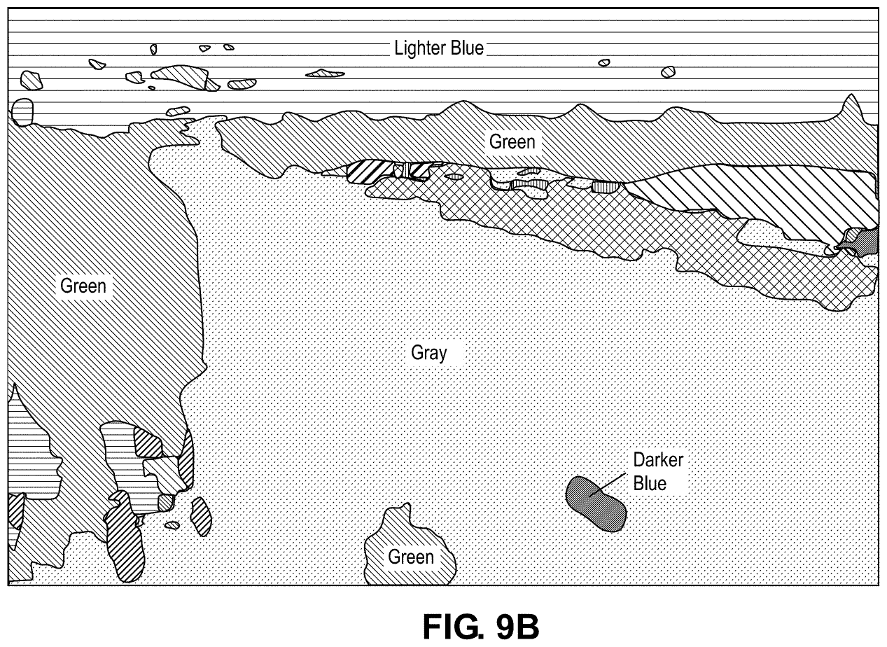

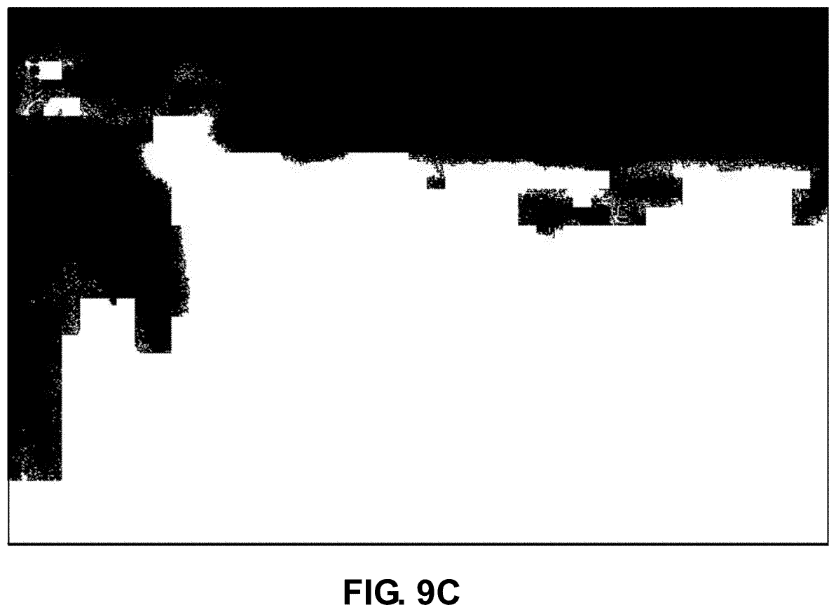

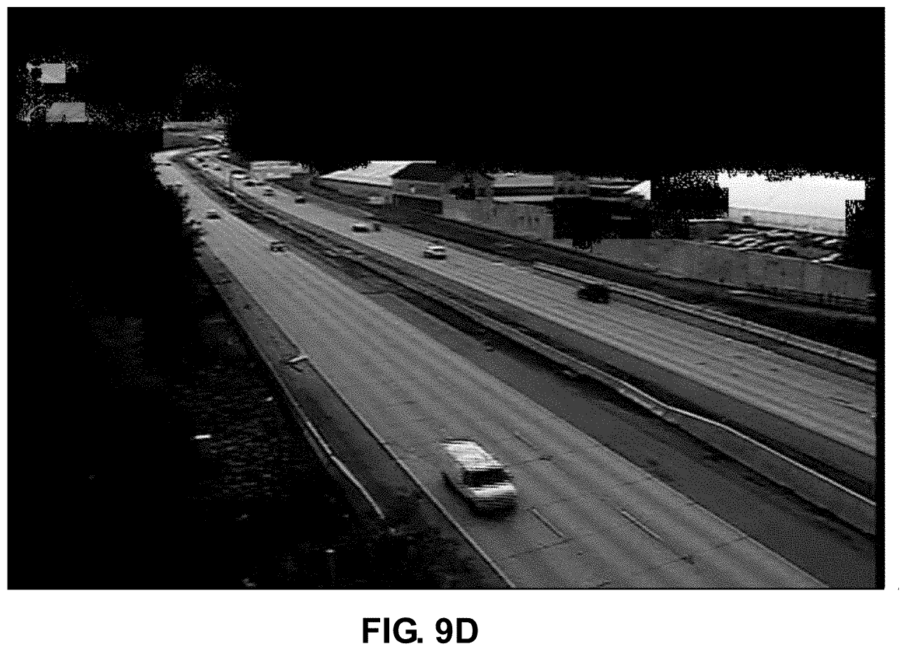

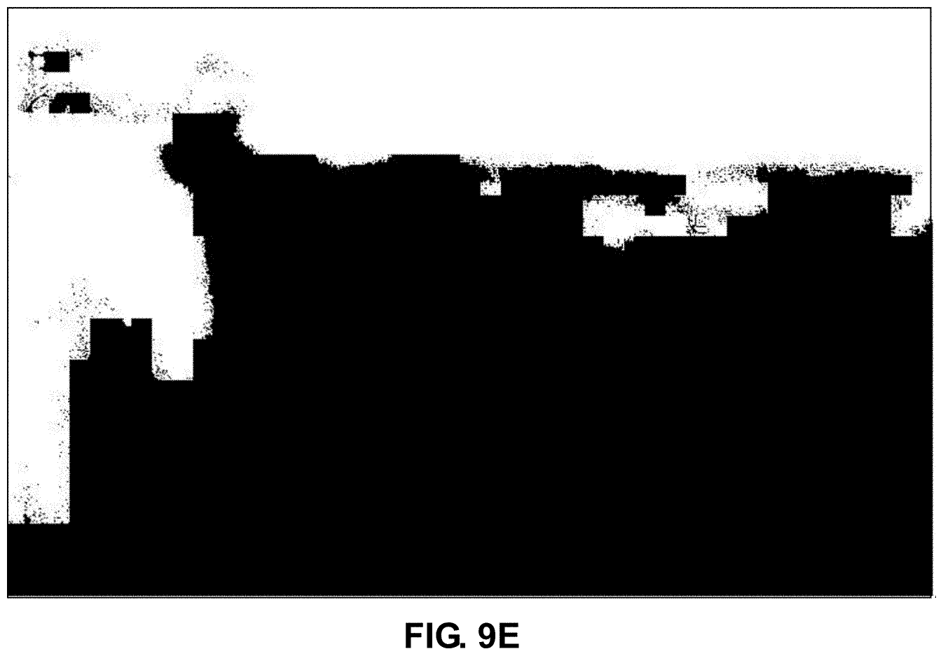

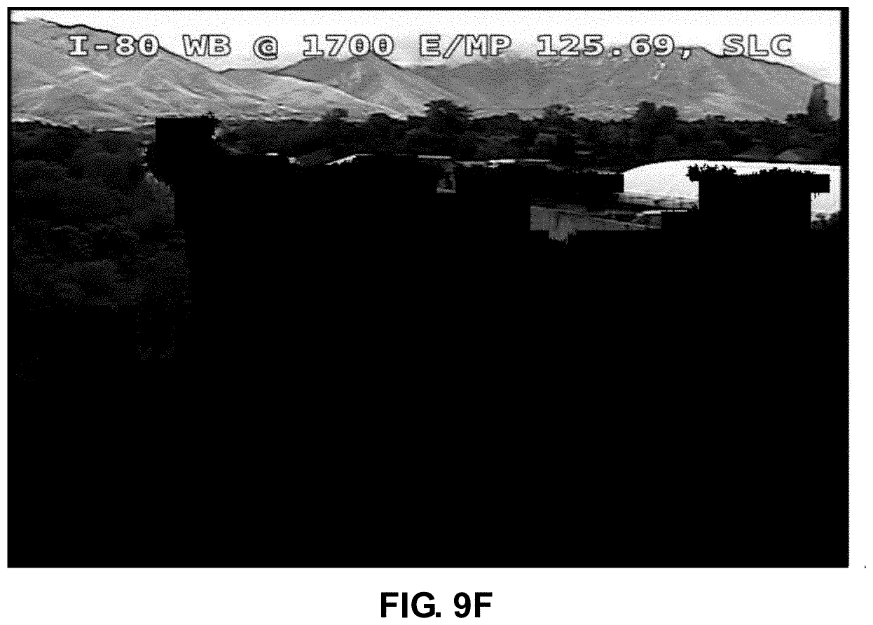

FIGS. 7B-7E more specifically depict using the modules of computer architecture 700 to segment video stream frames. FIG. 8 is a flow chart of an example method 800 for segmenting a video stream frame. Method 800 will be described with respect to the components and data in computer architecture 700.

Method 800 includes accessing a plurality of frames from a video stream (801). Camera 721 (e.g., a traffic camera or other public camera) can stream video stream 731. Color mask generator 701 can access frames 732A, 732B, . . . 732m, etc. from video stream 731.

Color mask generator 701 can process video stream 731 on a per frame basis. As such, for each of the plurality of frames, method 800 includes detecting a plurality of different object types in the frame (802). For example, in FIG. 7B, object detector 702 can detect objects 711A and 711B in frame 732A. Object detector 702 can determine that object 711A is of object type 712 (e.g., a roadway or roadway portion). Object detector 702 can determine that object 711B is of object type 713 (e.g., a vehicle, such as, a truck, a car, a bus, a van, a motorcycle, etc.)

For each of the plurality of frames, method 800 includes assigning colors to objects in the frame based on detected object type (803). Color assignment module 703 can refer to color mappings 717. Color mappings 717 can define mappings between object types and corresponding colors. For example, a roadway object type can be mapped to gray, a vehicle object type can be mapped to darker blue, a sky object type can be mapped to lighter blue, tree and bush object types can be mapped to green, etc. Accordingly, color assignment module 703 can assign color 714 (e.g., gray) to object 711A and can assign color 716 (e.g., darker blue) to object 711B.

For each of the plurality of frames, method 800 includes generating an object color mask from contents of the frame based on the assigned colors (804). For example, color mask generator 701 can generate color mask 728A (a color mask corresponding to video stream 731), including objects 711A, 712A, etc. In one aspect, color mask 728A is sent to color mask aggregator 707. In another aspect, color mask 728A is sent to subset detector 704.

Similarly, turning to FIG. 7C, object detector 702 can detect objects 711C and 711D in frame 732B. Object detector 702 can determine that object 711C is of object type 712 (e.g., a roadway or roadway portion). Object detector 702 can determine that object 711D is of object type 713 (e.g., a vehicle, such as, a truck, a car, a bus, a van, a motorcycle, etc.). Color assignment module 703 can assign color 714 (e.g., gray) to object 711C and can assign color 716 (e.g., darker blue) to object 711D. Color mask generator 701 can generate color mask 728B (a color mask corresponding to video stream 731), including objects 711C and 711D. In one aspect, color mask 728B is sent to color mask aggregator 707. In another aspect, color mask 728B is sent to subset detector 704.

For at least one frame included in the plurality of frames, method 800 includes assigning a first color to a first object in the frame based on a detected object type of the first object (805). For example, as described with respect to FIG. 7B, color assignment module 703 can assign color 714 to object 711A based on type 712. For the at least one frame included in the plurality of frames, method 800 includes assigning a second color to a different object in the frame based on another detected object type of the different object (806). Similarly, as described with respect to FIG. 7B, color assignment module 703 can assign color 716 to object 711B based on type 713.

Further, as described with respect to FIG. 7C, color assignment module 703 can assign color 714 to object 711C based on type 712. Similarly, as described with respect to FIG. 7C, color assignment module 703 can assign color 716 to object 711D based on type 713.

For the at least one frame included in the plurality of frames, method 800 includes determining that the detected object type and the other detected object type match a defined relationship (807). One or both of color mask 728A (corresponding to frame 732A) and color mask 728B (corresponding to frame 732B) can be sent to subset detector 704. Subset detector 704 can refer to object type relationships 718. Object type relationships 718 can define relationships between different object types. For example, object type relationships 718 can define relationship 718A between vehicles and roadways. Relationship 718A can define that vehicles detected within a roadway are to be considered (or re-typed for coloring, as opposed to object detection, as) part of the roadway. Relationships 718 can also define relationships between other combinations of described objects types, including between any of: roadway portions, vehicles, trees, bushes, guard rails, signs, walls, buildings, sky, etc.

As such, subset detector 704 can determine that object 711A (roadway) and object 711B (vehicle) match relationship 718A. For example, subset detector 104 can detect that object 711B (a vehicle object type) is within object 711A (a roadway portion object type). Thus, based on relationship 718A, subset detector 704 can determine that object 711B is to be assigned the color of object 711A. Subset detector 704 can alter a field value and/or attach an additional field to object 711B to indicate that color 716 is to be re-assigned to color 714. Subset detector 704 can include object 711B in subset 733A (a subset of objects that are to have colors re-assigned). Subset detector 704 can send subset 733A to color reassignment module 706.

In another aspect, subset detector 704 can determine that object 711C (roadway) and object 711D (vehicle) match relationship 718A. For example, subset detector 704 can detect that object 711D (a vehicle object type) is within object 711C (a roadway portion object type). Thus, subset detector 704 can determine that object 711D is to be assigned the color of object 711C. Subset detector 104 can alter a field value and/or attach an additional field to object 711D to indicate that color 716 is to be re-assigned to color 714. Subset detector 704 can include object 711D in subset 733B (a subset of objects that are to have colors re-assigned). Subset detector 704 can send subset 733B to color reassignment module 106.

For the at least one frame included in the plurality of frames, method 800 includes based on matching the predefined relationship, re-assigning the second color to the first object in the object color mask for the at least one frame (808). For example, in FIG. 7B, color reassignment module 706 receives subset 733A from subset detector 704. Referring to color mappings 717 color reassignment module 706 re-assigns colors to objects included in subset 733A. In one aspect, color reassignment module 706 accesses fields attached by subset detector 704. Color reassignment module 706 re-assigns colors to objects in accordance with the attached fields. For example, color reassignment module 706 can reassign color 714 to object 711B based on a field attached to object 711B by subset detector 704. Color mask generator 701 can output color mask 722B. As depicted, color mask 722A indicates that color 714 is assigned to both objects 711A and 711B.

In FIG. 7C, color reassignment module 706 receives subset 733B from subset detector 704. Referring to color mappings 717 color reassignment module 706 re-assigns colors to objects included in subset 733B. In one aspect, color reassignment module 706 accesses fields attached by subset detector 704. Color reassignment module 706 re-assigns colors to objects in accordance with the attached fields. For example, color reassignment module 706 can reassign color 714 to object 711D based on a field attached to object 711D by subset detector 704. Color mask generator 701 can output color mask 722B. As depicted, color mask 722B indicates that color 714 is assigned to both objects 711C and 711D.

Method 800 includes aggregating the respective generated object color masks from the at least two frames of video into an aggregate color mask (809). For example, turning to FIG. 7D, color mask aggregator 707 can aggregate color mask 722A (with color reassignments) (or 728A without color reassignments), color mask 722B (with color reassignments) (or 728B without color reassignments), and possibly additional color masks 791 (e.g., corresponding to additional frames of video stream 731) into aggregate color mask 723. Thus, one or more color masks including re-assigned colors can be aggregated with one another as well as with one or more other color masks. Color mask aggregator 707 can send aggregate color mask 723 to binary mask generator 708.

In one aspect, at least two color masks including objects with reassigned colors (e.g., color mask 722A and color mask 722B) (and potentially along with one or more other color masks, which may or may not include objects with reassigned colors) are aggregated into an aggregate color mask. In another aspect, one color mask including objects with reassigned colors (e.g., color mask 722A) is aggregated along with one or more other color masks (e.g., color mask 728B) (which may or may not have reassigned colors) into an aggregate color mask.

In one aspect, aggregating color masks includes averaging colors across color masks. Thus, when color masks corresponding to a sufficient number of frames are combined, roadway portion objects as well as other objects can be more efficiently distinguished.

Method 800 includes deriving a binary mask from the aggregate color mask (810). For example, binary mask generator 708 can generate binary mask 724 from aggregate color mask 723. Binary mask 724 can include a “1” or “0” per pixel of aggregate color mask 723. Generating binary mask 724 can include assigning a “1” to pixels assigned a specific color and assigning a “0” to pixels assigned all other colors. In one aspect, portions of aggregate color mask 723 assigned gray color (and, for example, thus corresponding to roadway portions) are assigned “1” and all other portions of aggregate color mask 723 are assigned “0”. Binary mask generator 708 can make binary mask 724 available to binary mask application module 709. In one aspect, binary mask 724 is stored in durable storage.

In FIGS. 7B and 7C, vehicles in a roadway are reassigned to a color defined for the roadway (e.g., gray). As such, the roadway can be more uniformly masked. That is, vehicles in the roadway cause little, if any, interruption in masking the roadway relative to other objects in frames 732A, 732B, etc.

Method 800 includes applying the binary mask to a further frame of the video stream to highlight roadway objects in the further image (811). For example, turning to FIG. 7E, binary masked application module 709 can access additional frames from video stream 731, such as, frames 732m through 732n (e.g., 732n can be received sometime after frame 732m). Binary mask application module 709 can also access binary mask 724 (e.g., from durable storage). Binary mask application module 709 can apply binary mask 724 to a frame 732 (e.g., 732n) to derive masked frame 726. Pixels of the frame (e.g., 732n) corresponding “1” in binary mask 724 can be depicted in masked frame 726. On the other hand, pixels of frame 732 corresponding “0” in binary mask 724 can be obscured (e.g., blacked out) in masked frame 726. Masked frame 726 can be sent to vehicle detector systems 792 (which may be included in an event detection infrastructure, such as, event detection infrastructure 103 in FIG. 1B).

In one aspect, all objects in a frame except those colored as roadway are obscured.

Although vehicles can be recolored for purposes of masking, vehicles can be considered based on initial coloring for purposes of vehicle detection. Vehicle detection systems 792 can receive masked frame 726 from binary mask application module 709. Vehicle detection systems 792 may ignore masked out portions of masked frame 726 when attempting to detect vehicles in frame 732n. Thus, less than all of the frame (e.g., 732n) is processed, conserving resources relative to processing an entire frame.

Thus, during binary mask derivation for a video stream, when an object of one object type is detected within another object of another object type the color assigned to the other object type is also assigned to the object type. For example, when a vehicle object is detected within a roadway object, the color assigned to the roadway object can also be assigned to the vehicle object. As such, a derived binary mask can better approximate the area of the other object type within one or more frames. For example, when deriving a binary mask for frames that include a roadway, vehicles on the roadway are considered part of the roadway. Thus, a derived binary mask better approximates the area of the roadway within the frames. For example, there are no “holes” in the binary mask due to vehicles detected in a roadway being assigned a different color than the roadway.

When the binary mask is applied to subsequent frames of the video stream, the area of the other object type can be more appropriately represented. Detecting objects of the object type can be focused on areas highlighted by the binary mask (e.g., areas assigned a binary ‘1’). For example, an area of a roadway can be more appropriately represented, and vehicle detection focused on the roadway. Focusing detection on portions of a frame highlighted by a binary mask conserves resources relative to processing an entire frame. For example, a binary mask can be applied to frames of a roadway environment to focus vehicle detection on a roadway and away from other portions of frames that are unlikely to include vehicles (e.g., the sky, bushes, trees, buildings, etc.).

An inverse binary mask can be used to present everything in a frame except objects assigned to specified color, for example, roads. An inverse binary mask can be used a reference frame to understand a camera's PTZ value. As such, if a camera configuration is altered, for example, zooms in, zooms out, rotates, changes angle, etc., the background would change, and fames may provide unusual detection values (relative to values prior to the configuration change). When camera configuration changes, the current background in the frame can be compared to the reference background image created by the inverse mask to identify a PTZ change. A PTZ change can trigger calibration modules to calibrate a camera accordingly.

In another aspect, color mask aggregator 707 includes the functionality of subset detector 704 and color reassignment module 706. Color mask aggregator 707 can identify subsets of objects in an aggregate color mask. Color mask aggregator 707 can refer to color mappings 717 to re-assign colors to objects. Reassigning colors in an aggregate color mask reduces the number of times color reassignment is performed. Further, aggregated color masks may include overlapping colors from multiple frames. When overlapping colors are re-assigned once, resources are conserved (relative to re-assigned colors per color mask).

The components in computer architecture 700 can be connected to (or be part of) a network, such as, for example, a system bus, a Local Area Network (“LAN”), a Wide Area Network (“WAN”), and even the Internet, along with components of computer architecture 100. Accordingly, the components as well as any other connected computer systems and their components can create and exchange data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network. As such, components in computer architectures 700 can interoperate with (or even be included in) components in computer architecture 100 to implement aspects of the invention.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A method comprising:
accessing a frame from a camera video stream;
generating a first object color mask from contents of the frame, including:
detecting objects of a plurality of different object types in the frame including a first instance of an object type and a first instance of another object type;
assigning a different color to different objects in the frame based on object type, including assigning a first color to the first instance of the object type and assigning a second color to the first instance of the other object type;
determining the first instance of the object type is within the first instance of the other object type; and
re-assigning the second color to the first instance of the object type;
accessing another frame from the camera video stream;
generating a second object color mask from contents of the other frame, including:
detecting other objects of the plurality of the different object types in the other frame including a second instance of the object type and a second instance of the other object type;
assigning a different color to different objects in the other frame based on the object type, including assigning the first color to the second instance of the object type and assigning a second color to the second instance of the other object type;
determining the second instance of the object type is within the second instance of the other object type; and
re-assigning the second color to the second instance of the object type;
combining the first object color mask and the second object color mask into an aggregate color mask;
computing a binary mask from the aggregate color mask, including assigning a binary value of one to portions of the aggregate color mask having the second color value and assigning a binary value of zero to portions of the aggregate color mask having other color values; and
applying the binary mask to a further frame from the camera video stream highlighting instances of the other object type in the further frame.

2. The method of claim 1, wherein detecting objects of a plurality of different object types in the frame comprises detecting a vehicle object and a roadway portion object in the frame;
wherein assigning a different color to different objects comprises assigning a first color to the vehicle object and a second color to the roadway portion object;
wherein determining the first instance of the object type is within the first instance of the other object type comprises determining that the vehicle object is in the roadway portion object; and
wherein re-assigning the second color to the first instance of the object type comprises reassigning the second color to the vehicle object.

3. The method of claim 2, wherein detecting objects of a plurality of different object types in the other frame comprises detecting another vehicle object and another roadway portion object in the other frame;
wherein assigning a different color to different objects comprises assigning a first color to the other vehicle object and a second color to the other roadway portion object;
wherein determining the second instance of the object type is within the second instance of the other object type comprises determining that the other vehicle object is in the other roadway portion object; and
wherein re-assigning the second color to the second instance of the object type comprises reassigning the second color to the other vehicle object.

4. The method of claim 3, wherein applying the binary mask to a further frame from the camera video stream comprises applying the binary mask highlighting a further roadway portion object in the further frame.

5. The method of claim 4, further comprising detecting one or more vehicle objects in the further frame, including:
limiting vehicle detection checking to highlighted roadway portion objects; and
detecting the one or more vehicle objects in the further roadway portion object.

6. The method of claim 4, wherein applying the binary mask comprises masking one or more of: a tree, a bush, a guard rail, a sign, a wall, a building, or a portion of sky out of the further frame.

7. The method of claim 3, wherein detecting another vehicle object and another roadway portion object in the other frame comprises re-detecting the vehicle object and the roadway portion object in the other frame.

8. The method of claim 1, wherein re-assigning the second color to the first instance of the object type comprises re-assigning the second color to the first instance of the object type based on a defined relationship between the object type and the other object type.

9. The method of claim 1, wherein applying the binary mask to a further frame comprises masking out portions of the further frame not associated with objects of the other object type.

10. The method of claim 1, wherein combining the first object color mask and the second object color mask into an aggregate color mask comprises comprising combining the first object color mask and the second object color mask into an average color mask.

11. A system comprising:
a processor; and
system memory coupled to the processor and storing instructions configured to cause the processor to:
access a frame from a camera video stream;
generate a first object color mask from contents of the frame, including:
detect objects of a plurality of different object types in the frame including a first instance of an object type and a first instance of another object type;
assign a different color to different objects in the frame based on object type, including assigning a first color to the first instance of the object type and assigning a second color to the first instance of the other object type;
determine the first instance of the object type is within the first instance of the other object type; and
re-assign the second color to the first instance of the object type;
access another frame from the camera video stream;
generate a second object color mask from contents of the other frame, including:
detect other objects of the plurality of the different object types in the other frame including a second instance of the object type and a second instance of the other object type;
assign a different color to different objects in the other frame based on the object type, including assigning the first color to the second instance of the object type and assigning a second color to the second instance of the other object type;
determine the second instance of the object type is within the second instance of the other object type; and
re-assign the second color to the second instance of the object type;
combine the first object color mask and the second object color mask into an aggregate color mask;
compute a binary mask from the aggregate color mask, including assigning a binary value of one to portions of the aggregate color mask having the second color value and assigning a binary value of zero to portions of the aggregate color mask having other color values; and
apply the binary mask to a further frame from the camera video stream highlighting instances of the other object type in the further frame.

12. The system of claim 1, wherein instructions configured to detect objects of a plurality of different object types in the frame comprise instructions configured to detect a vehicle object and a roadway portion object in the frame;
wherein instructions configured to assign a different color to different objects comprise instructions configured to assign a first color to the vehicle object and a second color to the roadway portion object;
wherein instructions configured to determine the first instance of the object type is within the first instance of the other object type comprise instructions configured to determine that the vehicle object is in the roadway portion object; and
wherein instructions configured to re-assign the second color to the first instance of the object type comprise instructions configured to reassign the second color to the vehicle object.

13. The system of claim 12, wherein instructions configured to detect objects of a plurality of different object types in the other frame comprise instructions configured to detect another vehicle object and another roadway portion object in the other frame;
wherein instructions configured to assign a different color to different objects comprise instructions configured to assign a first color to the other vehicle object and a second color to the other roadway portion object;
wherein instructions configured to determine the second instance of the object type is within the second instance of the other object type comprises instructions configured to determine that the other vehicle object is in the other roadway portion object; and
wherein instructions configured to re-assign the second color to the second instance of the object type comprise instructions configured to reassign the second color to the other vehicle object.

14. The system of claim 13, wherein instructions configured to apply the binary mask to a further frame from the camera video stream comprise instructions configured to apply the binary mask highlighting a further roadway portion object in the further frame.

15. The system of claim 14, further comprising instructions configured to detect one or more vehicle objects in the further frame, including instructions configured to:
limit vehicle detection checking to highlighted roadway portion objects; and
detect the one or more vehicle objects in the further roadway portion object.

16. The system of claim 14, wherein instructions configured to apply the binary mask comprise instructions configured to mask one or more of: a tree, a bush, a guard rail, a sign, a wall, a building, or a portion of sky out of the further frame.

17. The system of claim 13, wherein instructions configured to detect another vehicle object and another roadway portion object in the other frame comprise instructions configured to re-detect the vehicle object and the roadway portion object in the other frame.

18. The system of claim 11, wherein instructions configured to re-assign the second color to the first instance of the object type comprise instructions configured to re-assign the second color to the first instance of the object type based on a defined relationship between the object type and the other object type.

19. The system of claim 11, wherein instructions configured to apply the binary mask to a further frame comprise instructions configured to mask out portions of the further frame not associated with objects of the other object type.

20. The system of claim 11, wherein instructions configured to combine the first object color mask and the second object color mask into an aggregate color mask comprise instructions configured to combine the first object color mask and the second object color mask into an average color mask.
